(19) United States
(12) Patent Application Publication
(10) Pub. No.: US 2023/0077259 A1
(43) Pub. Date: Mar. 9, 2023

(54) Virtual Validation and Verification Model Structure for Motion Control

(71) Applicant: WAYMO LLC, Mountain View, CA (US)

(72) Inventors: Diomidis Katzourakis, San Jose, CA (US); Justin Zaydel, Mountain View, CA (US)

(21) Appl. No.: 17/408,734

(22) Filed: Aug. 23, 2021

(51) Int. Cl. B62D 15/02; B60W 60/00

(52) U.S. Cl. CPC B62D 15/021; B62D 15/025; B60W 60/001; B60W 2520/30; B60W 2520/26; B60W 2520/20

(57) ABSTRACT

The technology employs a model structure for motion control in a vehicle configured to operate in an autonomous driving mode. The model structure has components including a vehicle dynamics system module, a column dynamics module, a rack dynamics module, and an actuation control module. A virtual validation and verification model is configurable based on the components of the model structure. Configuration is performed according to a set of operational requirements based on at least one of a vehicle type, occupant loading information, a center of gravity, or tire pressure as per a cold nominal setpoint. The virtual validation and verification model can be executed so that an electric power steering (EPS) module of the model structure components is configured for at least one of: a software-in-loop model, functional EPS assist, angle control, or to emulate an EPS controller.

### BACKGROUND

Autonomous vehicles, such as vehicles that do not require a human driver, can be used to aid in the transport of passengers or cargo from one location to another. Such vehicles may operate in a fully autonomous mode or a partially autonomous mode where a person may provide some driving input. Electric power steering (EPS) can facilitate fully or partially autonomous driving. However, ensuring that the EPS subsystem meets predetermined metrics and operates as intended with an autonomous vehicle may require a rigorous qualification process.

### BRIEF SUMMARY

The technology relates to a model structure for an EPS subsystem for a vehicle capable of operating in an autonomous driving mode. The model structure provides a multi-degree of freedom vehicle dynamics model. The model is used in a virtual verification methodology when evaluating the EPS subsystem as part of hardware-in-loop (HIL) testing or software-in-loop (SIL) integration. According to one aspect, the model structure contains control and dynamic behavior characteristics. EPS evaluation can include changing such characteristics to see how the EPS subsystem reacts. The methodology may comprise a Monte Carlo virtual verification methodology.

According to one aspect of the technology a system is provided that includes memory and one or more processors. The memory that stores computer-executable components to implement a model structure for motion control in a vehicle configured to operate in an autonomous driving mode. The one or more processors are operatively coupled to the memory. The one or more processors are configured to execute the components in a virtual validation and verification model. The components include: a vehicle dynamics system module that contains information regarding vehicle planar dynamics and rack reaction forces of the vehicle; an electric power steering (EPS) module; a column dynamics module associated with a steering column of the vehicle; a rack dynamics module; and an actuation control module. The virtual validation and verification model is initially configured according to a set of operational requirements based on at least one of a vehicle type, occupant loading information, a center of gravity, or tire pressure as per a cold nominal setpoint.

In one example, the virtual validation and verification model further includes a set of specific maneuver definitions selected from the group consisting of: sine steer, ramp steer, step steer, parking effort, a set of static steering kinematic properties, a suspension inertia identification, and suspension jacking effects.

In another example, the vehicle dynamics system module includes data for a vehicle system, in which the vehicle system has a set of chassis/dynamics equations. The vehicle dynamics system module may further include kinematics and compliance information, in which the kinematics and compliance information are used to estimate final road wheel angles for each wheel of the vehicle. The vehicle dynamics system module may further include an axle model, in which the axle model estimates rack reaction forces subject to vehicle states and a wheels aligning moment around a z-axis. The vehicle dynamics system module may further include body vehicle movement, in which the body vehicle movement translates the vehicle states to global coordinates. The axle model can be used to calculate the wheels aligning moment around the z-axis by calculating a front tires total aligning torque, a rear tires total aligning torque, and a jacking torque. The axel model can be further used to calculate a rack reaction force based on the front tires total aligning torque multiplied by a steering arm length. The axle model may be used by a kinematics and compliance module to calculate one or more tire angles. Here, the one or more tire angles may be used by a vehicle system module to determine vehicle state information in accordance with mu scaling and slip information. The vehicle state information may include at least one of a body-chassis translation, an angular positions, or an acceleration. And the vehicle state information may be used in a feedback loop to modify the axle model.

In another example, the EPS module is configured for at least one of a software-in-loop model, functional EPS assist, or angle control. Alternatively or additionally, the EPS module is configured to emulate an EPS controller that contains at least one of a torque controller, driver override logic, torsion bar transmission information, or a variable steering ratio. The column dynamics module may be associated with a set of steering parameters that include one or more of: a steering rack mass and friction parameter, mechanical properties of the steering column, torsion bar parameters, or an EPS transmission ratio for pinion and motor transmission. The rack dynamics module may employ one or more parameters and functions to either simulate a rack endstop or to blend simulated and logged rack position/rate information. And the actuation control module may be used in simulations to control wheel longitudinal slip.

[symbol]

In a further example, the system further comprises an experiment control module. The experiment control module may be configured to implement a set of simulations in one or more driving modes including a manual mode, a partially autonomous configuration with driver takeover, or a fully autonomous configuration with no driver takeover. And alternatively or additionally, the system may further comprise an EPS log block configured to collect EPS-based signals.

According to another aspect of the technology, a computer-implemented method is provided. The method includes storing computer-executable components to implement a model structure for motion control in a vehicle configured to operate in an autonomous driving mode. The computer-executable components include: a vehicle dynamics system module that contains information regarding vehicle planar dynamics and rack reaction forces of the vehicle; an electric power steering (EPS) module; a column dynamics module associated with a steering column of the vehicle; a rack dynamics module; and an actuation control module. The method also includes configuring, by one or more processors, a virtual validation and verification model based on the computer-executable components. The configuring is performed according to a set of operational requirements based on at least one of a vehicle type, occupant loading information, a center of gravity, or tire pressure as per a cold nominal setpoint. And the method also includes executing, by one or more processors, the virtual validation and verification model. Here, the EPS module is configured for at least one of: a software-in-loop model, functional EPS assist, angle control, or to emulate an EPS controller that contains at least one of a torque controller, driver override logic, torsion bar transmission information, or a variable steering ratio.

### BRIEF DESCRIPTION OF THE DRAWINGS

FIGS. 1A-B illustrate an example passenger-type vehicle configured for use with aspects of the technology.

FIG. 2 illustrates an example electronic power steering subsystem associated with aspects of the technology.

FIG. 3 is a block diagram of systems of an example passenger-type vehicle in accordance with aspects of the technology.

FIGS. 4A-B illustrate degrees of freedom for a model structure in accordance with aspects of the technology.

FIGS. 5A-B illustrate tire-related information in accordance with aspects of the technology.

FIG. 6 illustrates a vehicle body diagram in accordance with aspects of the technology.

FIG. 7 illustrates a load transfer diagram in accordance with aspects of the technology.

FIG. 8 illustrates an example model structure in accordance with aspects of the technology.

FIG. 9 illustrates a block diagram in accordance with aspects of the technology.

FIG. 10 illustrates a flow diagram for a planar dynamics module in accordance with aspects of the technology.

FIGS. 11A-E illustrate validation examples in accordance with aspects of the technology.

FIGS. 12A-E illustrate additional validation examples in accordance with aspects of the technology.

FIGS. 13A-E illustrate parking-related validation examples in accordance with aspects of the technology.

FIGS. 14A-E illustrate slow-speed rolling-related validation examples in accordance with aspects of the technology.

FIGS. 15A-B illustrates an example system in accordance with aspects of the technology.

FIG. 16 illustrates an example method in accordance with aspects of the technology.

### DETAILED DESCRIPTION

Evaluating new components for vehicles can be challenging, particularly when the vehicles are configured to operate in an autonomous driving mode with no or minimal human driver input. Certain components, such as an EPS subsystem, may have very specific requirements. One approach to evaluating the EPS subsystem is via a virtual validation and verification methodology. Here, the virtual testing may involve software-in-the-loop (SIL) and hardware-in-the-loop (HIL) with an integrated vehicle dynamics model-in-the-loop (MIL). Defining a robust vehicle dynamics model that avoids unnecessary complexity can be especially important to ensure proper virtual testing, especially when providing a fully operational vehicle for testing is not feasible.

### Example Vehicle Systems

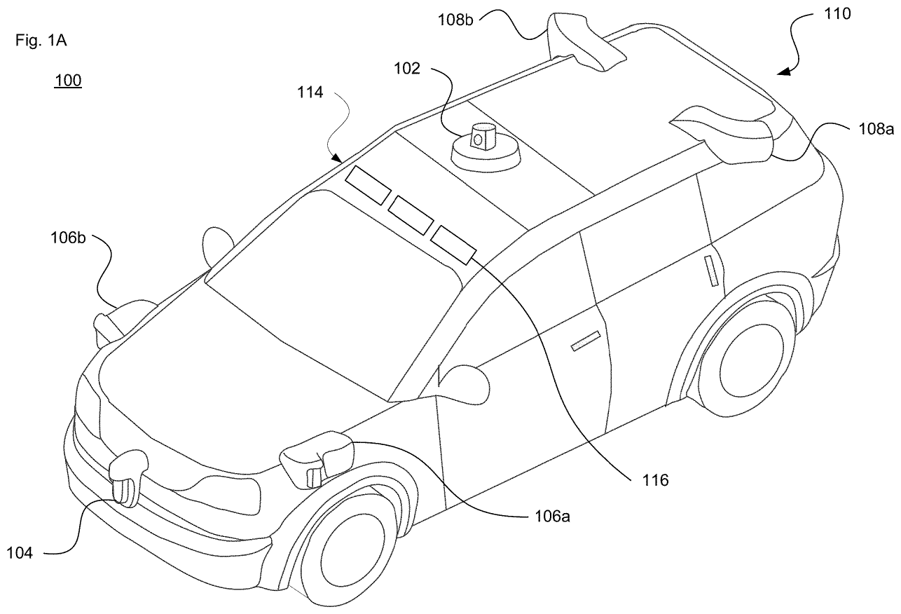

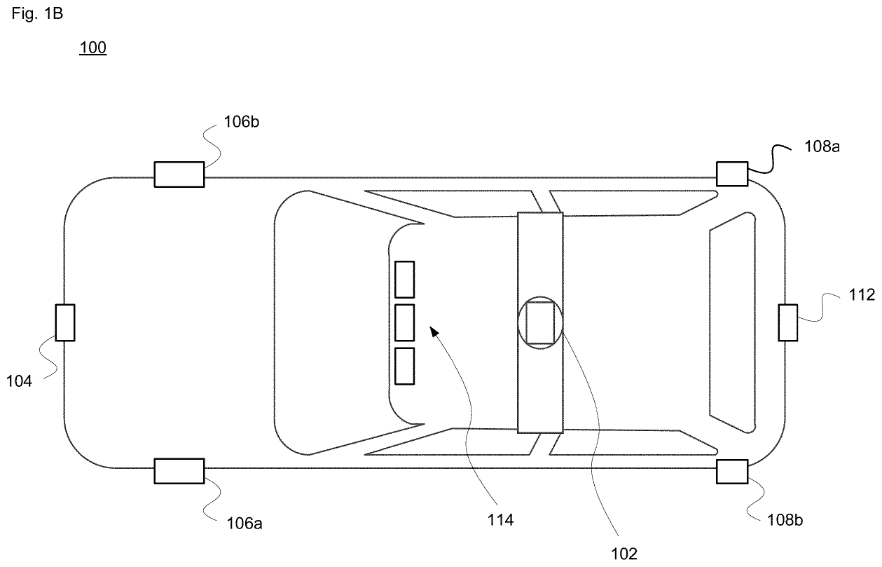

FIG. 1A illustrates a perspective view of an example passenger vehicle 100, such as a minivan, sport utility vehicle (SUV) or other vehicle that may employ an EPS subsystem in accordance with aspects of the technology. The EPS subsystem may be anything that applies a torque-force to steer a vehicle that is actively controlled via software. This could be a fully electric rack-and-pinion style hardware such as typically used for passenger vehicles, or an electro-hydraulic system, which is more typical for larger vehicles such as cargo truck. FIG. 1B illustrates a top-down view of the passenger vehicle 100. The passenger vehicle 100 may include various sensors for obtaining information about the vehicle's external environment. For instance, a roof-top housing 102 may include a lidar sensor as well as various cameras, radar units, infrared and/or acoustical sensors. Housing 104, located at the front end of vehicle 100, and housings 106a, 106b on the driver's and passenger's sides of the vehicle may each incorporate lidar, radar, camera and/or other sensors. For example, housing 106a may be located in front of the driver's side door along a quarter panel of the vehicle. As shown, the passenger vehicle 100 also includes housings 108a, 108b for radar units, lidar and/or cameras also located towards the rear roof portion of the vehicle. Additional lidar, radar units and/or cameras (not shown) may be located at other places along the vehicle 100. For instance, arrow 110 indicates that a sensor unit (112 in FIG. 1B) may be positioned along the rear of the vehicle 100, such as on or adjacent to the bumper. And arrow 114 indicates a series of sensor units 116 arranged along a forward-facing direction of the vehicle. In some examples, the passenger vehicle 100 also may include various sensors for obtaining information about the vehicle's interior spaces (not shown).

By way of example, each sensor unit may include one or more sensors, such as lidar, radar, camera (e.g., optical or infrared), acoustical (e.g., microphone or sonar-type sensor), inertial (e.g., accelerometer, gyroscope, etc.) or other sensors (e.g., positioning sensors such as GPS sensors). While certain aspects of the disclosure may be particularly useful in connection with specific types of vehicles, the vehicle may be any type of vehicle including, but not limited to, cars, panel vans, buses, recreational vehicles, etc.

There are different degrees of autonomy that may occur for a vehicle operating in a partially or fully autonomous driving mode. The U.S. National Highway Traffic Safety Administration and the Society of Automotive Engineers have identified different levels to indicate how much, or how little, the vehicle controls the driving. For instance, Level 0 has no automation and the driver makes all driving-related decisions. The lowest semi-autonomous mode, Level 1, includes some drive assistance such as cruise control. Level 2 has partial automation of certain driving operations, while Level 3 involves conditional automation that can enable a person in the driver's seat to take control as warranted. In contrast, Level 4 is a high automation level where the vehicle is able to drive without assistance in select conditions. And Level 5 is a fully autonomous mode in which the vehicle is able to drive without assistance in all situations. The models, architectures, components, systems and methods described herein may be designed to function according to semi or fully-autonomous modes such as Levels 2-4 or 2-5, which are referred to herein as autonomous driving modes. Thus, reference to an autonomous driving mode may include partial and/or full autonomy.

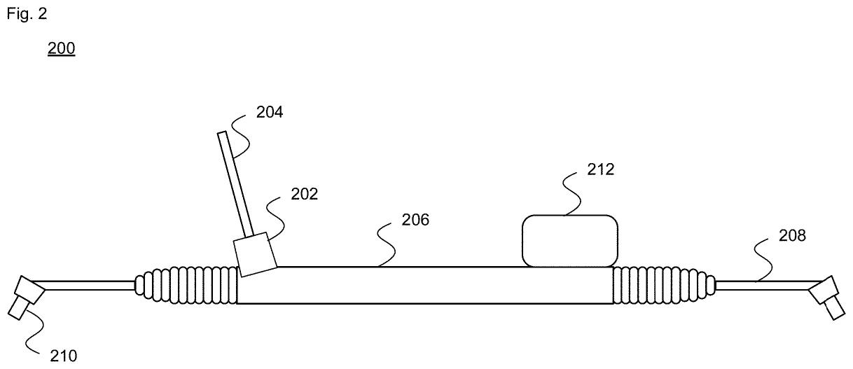

FIG. 2 illustrates an example electronic power steering subsystem 200, which may be evaluated according to a virtual validation and verification method. In this example, the subsystem 200 has a rack and pinion mechanism 202 that is coupled to steering column 204 and steering rack unit 206. The mechanism 202 may include a torque sensor. The steering rack unit 206 may include a recirculating ball gear (not shown). Tie rods 208 extend from either end of the steering rack unit 206, with hub units 210 configured for coupling to the vehicle's wheels (not shown). An electric motor 212 is operatively coupled to the steering rack unit 206. The electric motor 208 may include an integrated steering control unit (not shown) that enables both fully and partially autonomous driving modes. In an autonomous driving mode, the steering control unit is able to receive a position or torque command from the network such as a Controller Area Network (CAN) bus, FlexRay, etc., (as well as information about other vehicle parameters) in order to determine an appropriate amount of steering support. This information is used by the electric motor 212 to provide steering assistance as needed.

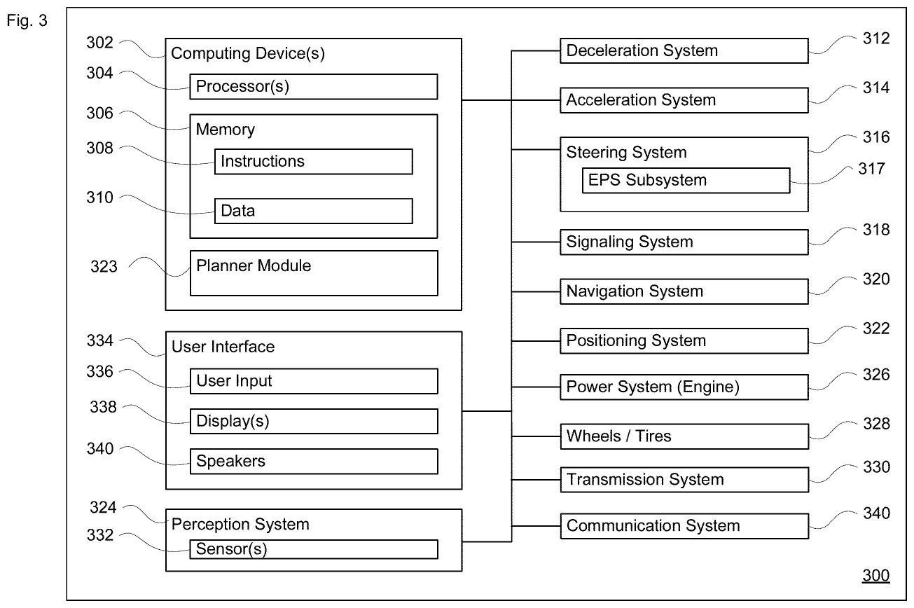

FIG. 3 illustrates a block diagram 300 with various components and systems of an exemplary vehicle, such as passenger vehicle 100, to operate in an autonomous driving mode. As shown, the block diagram 300 includes one or more computing devices 302, such as computing devices containing one or more processors 304, memory 306 and other components typically present in general purpose computing devices. The memory 306 stores information accessible by the one or more processors 304, including instructions 308 and data 310 that may be executed or otherwise used by the processor(s) 304. The computing system may control overall operation of the vehicle when operating in an autonomous driving mode.

The memory 306 stores information accessible by the processors 304, including instructions 308 and data 310 that may be executed or otherwise used by the processors 304. The memory 306 may be of any type capable of storing information accessible by the processor, including a computing device-readable medium. The memory is a non-transitory medium such as a hard-drive, memory card, optical disk, solid-state, etc. Systems may include different combinations of the foregoing, whereby different portions of the instructions and data are stored on different types of media.

The instructions 308 may be any set of instructions to be executed directly (such as machine code) or indirectly (such as scripts) by the processor(s). For example, the instructions may be stored as computing device code on the computing device-readable medium. In that regard, the terms “instructions”, “modules” and “programs” may be used interchangeably herein. The instructions may be stored in object code format for direct processing by the processor, or in any other computing device language including scripts or collections of independent source code modules that are interpreted on demand or compiled in advance. The data 310 may be retrieved, stored or modified by one or more processors 304 in accordance with the instructions 308. In one example, some or all of the memory 306 may be an event data recorder or other secure data storage system configured to store vehicle diagnostics and/or detected sensor data, which may be on board the vehicle or remote, depending on the implementation.

The processors 304 may be any conventional processors, such as commercially available CPUs. Alternatively, each processor may be a dedicated device such as an ASIC or other hardware-based processor. Although FIG. 3 functionally illustrates the processors, memory, and other elements of computing devices 302 as being within the same block, such devices may actually include multiple processors, computing devices, or memories that may or may not be stored within the same physical housing. Similarly, the memory 306 may be a hard drive or other storage media located in a housing different from that of the processor(s) 304. Accordingly, references to a processor or computing device will be understood to include references to a collection of processors or computing devices or memories that may or may not operate in parallel.

In one example, the computing devices 302 may form an autonomous driving computing system incorporated into vehicle 300. The autonomous driving computing system may capable of communicating with various components of the vehicle. For example, the computing devices 302 may be in communication with various systems of the vehicle, including a driving system including a deceleration system 312 (for controlling braking of the vehicle), acceleration system 314 (for controlling acceleration of the vehicle), steering system 316 including an EPS subsystem (for controlling the orientation of the wheels and direction of the vehicle), signaling system 318 (for controlling turn signals), navigation system 320 (for navigating the vehicle to a location or around objects) and a positioning system 322 (for determining the position of the vehicle, e.g., including the vehicle's pose). The autonomous driving computing system may employ a planner module 323, in accordance with the navigation system 320, the positioning system 322 and/or other components of the system, e.g., for determining a route from a starting point to a destination or for making modifications to various driving aspects in view of current or expected traction conditions.

The computing devices 302 are also operatively coupled to a perception system 324 (for detecting objects in the vehicle's environment), a power system 326 (for example, a battery and/or internal combustion engine) and a transmission system 330 in order to control the movement, speed, etc., of the vehicle in accordance with the instructions 308 of memory 306 in an autonomous driving mode which does not require or need continuous or periodic input from a passenger of the vehicle. Some or all of the wheels/tires 328 are coupled to the transmission system 330, e.g., via the EPS subsystem 317, and the computing devices 302 may be able to receive information about tire pressure, balance and other factors that may impact driving in an autonomous mode.

The computing devices 302 may control the direction and speed of the vehicle, e.g., via the planner module 323, by controlling various components. By way of example, computing devices 302 may navigate the vehicle to a destination location completely autonomously using data from the map information and navigation system 320. Computing devices 302 may use the positioning system 322 to determine the vehicle's location and the perception system 324 to detect and respond to objects when needed to reach the location safely. In order to do so, computing devices 302 may cause the vehicle to accelerate (e.g., by increasing fuel or other energy provided to the engine by acceleration system 314), decelerate (e.g., by decreasing the fuel supplied to the engine, changing gears, and/or by applying brakes by deceleration system 312), change direction (e.g., by turning the front or other wheels of vehicle 100 by steering system 316 under management by the EPS subsystem 317), and signal such changes (e.g., by lighting turn signals of signaling system 318). Thus, the acceleration system 314 and deceleration system 312 may be a part of a drivetrain or other type of transmission system 330 that includes various components between an engine of the vehicle and the wheels of the vehicle. Again, by controlling these systems, computing devices 302 may also control the transmission system 330 of the vehicle in order to maneuver the vehicle autonomously.

Navigation system 320 may be used by computing devices 302 in order to determine and follow a route to a location. In this regard, the navigation system 320 and/or memory 306 may store map information, e.g., highly detailed maps that computing devices 202 can use to navigate or control the vehicle. As an example, these maps may identify the shape and elevation of roadways, lane markers, intersections, crosswalks, speed limits, traffic signal lights, buildings, signs, real time traffic information, vegetation, or other such objects and information. The lane markers may include features such as solid or broken double or single lane lines, solid or broken lane lines, reflectors, etc. A given lane may be associated with left and/or right lane lines or other lane markers that define the boundary of the lane. Thus, most lanes may be bounded by a left edge of one lane line and a right edge of another lane line.

The perception system 324 includes sensors 332 for detecting objects external to the vehicle. The detected objects may be other vehicles, obstacles in the roadway, traffic signals, signs, trees, etc. The sensors may 332 may also detect certain aspects of weather conditions, such as snow, rain or water spray, or puddles, ice or other materials on the roadway.

By way of example only, the perception system 324 may include one or more light detection and ranging (lidar) sensors, radar units, cameras (e.g., optical imaging devices, with or without a neutral-density filter (ND)), positioning sensors (e.g., gyroscopes, accelerometers and/or other inertial components), infrared sensors, acoustical sensors (e.g., microphones or sonar transducers), and/or any other detection devices that record data which may be processed by computing devices 302. Such sensors of the perception system 324 may detect objects outside of the vehicle and their characteristics such as location, orientation, size, shape, type (for instance, vehicle, pedestrian, bicyclist, etc.), heading, speed of movement relative to the vehicle, etc. The perception system 324 may also include other sensors within the vehicle to detect objects and conditions within the vehicle, such as in the passenger compartment. For instance, such sensors may detect, e.g., one or more persons, pets, packages, etc., as well as conditions within and/or outside the vehicle such as temperature, humidity, etc. Still further sensors 332 of the perception system 324 may measure the rate of rotation of the wheels 328, an amount or a type of braking by the deceleration system 312, torque information, and/or other factors associated with the equipment and operation of the vehicle itself.

As discussed further below, the raw data obtained by the sensors can be processed by the perception system 324 and/or sent for further processing to the computing devices 302 periodically or continuously as the data is generated by the perception system 324. Computing devices 302 may use the positioning system 322 to determine the vehicle's location and perception system 324 to detect and respond to objects when needed to reach the location safely, e.g., via adjustments made by planner module 323, including adjustments in operation to deal with occlusions and other issues. In addition, the computing devices 302 may perform calibration of individual sensors, all sensors in a particular sensor assembly, or between sensors in different sensor assemblies or other physical housings.

As illustrated in FIGS. 1A-B, certain sensors of the perception system 324 may be incorporated into one or more sensor assemblies or housings. In one example, these may be integrated into the side-view mirrors on the vehicle. In another example, other sensors may be part of the roof-top housing 102, or other sensor housings or units 106a,b, 108a,b, 112 and/or 116. The computing devices 302 may communicate with the sensor assemblies located on or otherwise distributed along the vehicle. Each assembly may have one or more types of sensors such as those described above.

Returning to FIG. 3, computing devices 302 may include all of the components normally used in connection with a computing device such as the processor and memory described above as well as a user interface subsystem 334. The user interface subsystem 334 may include one or more user inputs 336 (e.g., a mouse, keyboard, touch screen and/or microphone) and one or more display devices 338 (e.g., a monitor having a screen or any other electrical device that is operable to display information). In this regard, an internal electronic display may be located within a cabin of the vehicle (not shown) and may be used by computing devices 302 to provide information to passengers within the vehicle. Other output devices, such as speaker(s) 340 may also be located within the passenger vehicle.

The vehicle also includes a communication system 342. For instance, the communication system 342 may also include one or more wireless configurations to facilitate communication with other computing devices, such as passenger computing devices within the vehicle, computing devices external to the vehicle such as in another nearby vehicle on the roadway, and/or a remote server system. The communication connections may include short range communication protocols such as Bluetooth™, Bluetooth™ low energy (LE), cellular-type connections, as well as various configurations and protocols including the Internet, World Wide Web, intranets, virtual private networks, wide area networks, local networks, private networks using communication protocols proprietary to one or more companies. Ethernet, WiFi and HTTP, and various combinations of the foregoing.

### Example Implementations

As noted above, according to one aspect of the technology a model structure is employed that provides a vehicle dynamics model (for instance, one with multiple tracks and 4 or more degrees of freedom), which can be used when performing virtual validation and verification of an EPS subsystem. The model structure contains selected characteristics in terms of control and dynamic behavior, for instance to perform fundamental changes in characteristics such as to change basic tire properties emulating the effects of tire pressure changes or friction coefficient changes, moving the center of gravity height, accounting for the effects of road banking and grade, etc. In one scenario, the model is designed so as to run stable on a 1 millisecond (ms) fixed time step Euler solver for use with HIL hardware testing or SIL software integration. The model also enables simulations to be started with a set of initial conditions for certain states.

The model structure is widely applicable in various use cases. For instance, one use case involves a non-linear tire model with combined longitudinal-lateral forces. By way of example, heavy braking events in combination with steering would effectively change the rack forces. Low speed maneuvers may be emulated, such as to evaluate parking efforts involving turn slip effects. Another use case is to emulate steering-suspension rack forces in the model to minimize the need of experimental rack model data. This gives an engineer, developer or other user higher flexibility for simulation and enables synthesized driving maneuvers. A further use case evaluates fail-operational performance, while a further use case involves hand-steering wheel human interference. Here, the model structure provides the ability of the actuator to reject human input, and for validation of actuator diagnostics (e.g., blocked actuator detection). For instance, when the EPS is controlling to a specific rack position (tire angle) and a human applies torque to the handwheel, the EPS can use its available torque capacity to oppose/reject the human's attempt to steer the vehicle. Yet another use case involves diagnostic functions verification; such as freezing water impact, or thermal derating. With thermal derating, if the electronics or the motor within the EPS are exceed a temperature constraint, the overall output (torque capability) of the EPS will be reduced. Depending on the amount of the reduction, this can impact the ability of the EPS to steer the vehicle. The simulation can be used to determine the impact/severity of this reduction in performance. And a further use case is to evaluate disturbance inputs. Here, the system can, for example, evaluate potholes, a washboard road surface, curb strike disturbance inputs added to the rack from logged experimental data, as well as mu transitions. Mu Transitions involve changes in the surface friction, for example driving from a section of asphalt onto a patch of ice.

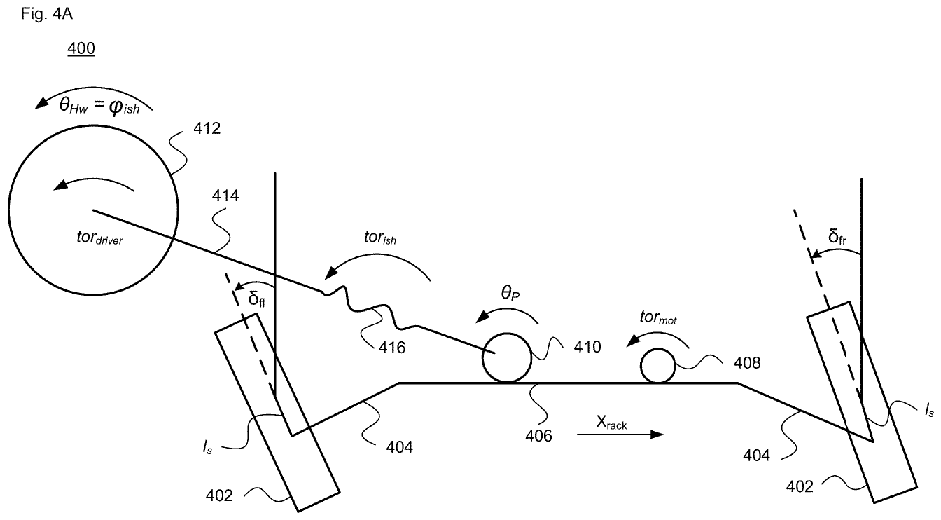

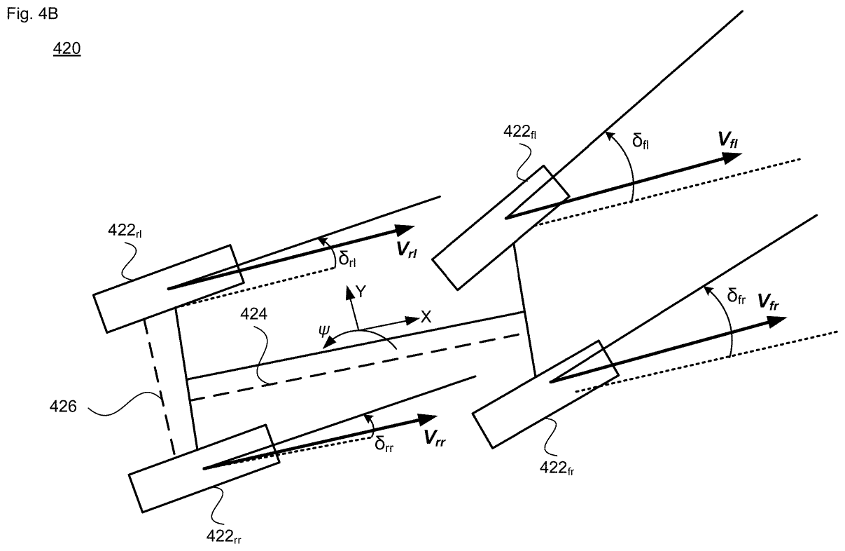

FIGS. 4A-B illustrate examples for the degrees of freedom for the model structure. As shown in view 400 of FIG. 4A, wheels 402 are coupled to tie rods 404, which are coupled to respective ends of steering rack unit 406. A motor gear 408 engages the steering rack unit 406. Pinion gear 410 is coupled to the steering rack unit 406 and is engaged with hand wheel (steering wheel) 412 via input shaft 414 and torsion bar 416. As noted in this figure, there is a translational angle degree of freedom for the steering rack displacement (rack position x_{rack}), which is positive to the right (unit of m). The front right wheel has a wheel angle δ_{fr} and the left front wheel has a wheel angle δ_{fl} (radians). The motor gear 408 has a torque torₘₒₜ, the input shaft 414 has a torque torᵢₛₕ, and the external torque to the steering wheel (driver) is tor_{driver} (each in units of Nm). Here, tor_{driver} is associated with the steering wheel interface. A hand wheel angle Θ_{Hw} is equal to the EPS input shaft angle Φᵢₛₕ (in degrees or radians), which assumes an infinitely stiff steering column with no nonlinearities due to the u-joints. The hand wheel angle Θ_{Hw} is a rotational dynamics degree of freedom. Pinion angle is Θ_{P} (in radians). The rack position x_{rack} and the pinion angle Θ_{P} are assumed to be the same degree of freedom (translational ↔ rotational via the steering rack ratio, c-factor). Thus, the pinion angle is equated to a transmission ratio for the rack position. Iₛ represents the steering arm length, in particular a normalized distance from the wheel's rotation axis z to the tie rod interface (404). 100481 As shown in view 420 of FIG. 4B, the right and left front and rear wheels 422 (422_{fr}, 422_{fl}, 422ᵣᵣ, 422ᵣₗ) each has a corresponding wheel angle δ_{fr}, δ_{fl}, δᵣᵣ δᵣₗ, and speed vector V_{fr}, V_{fl}, Vᵣᵣ Vᵣₗ, respectively (that can be decomposed to longitudinal and lateral speed components in the wheels' axis system). This representation of the vehicle has a wheel base 424 and a track width 426. This figure also shows degrees of freedom per the longitudinal position (X axis) and lateral position (Y axis) at the center of gravity, and the yaw angle ψ. For the front axle inertia, everything can be referred to the steering rack body, which can be a constant value referred to the steering rack coordinate frame (thus mass). As discussed further herein, vehicle speed will refer to the vehicle speed along the X axis. Lateral acceleration refers to the vehicle acceleration along the Y axis.

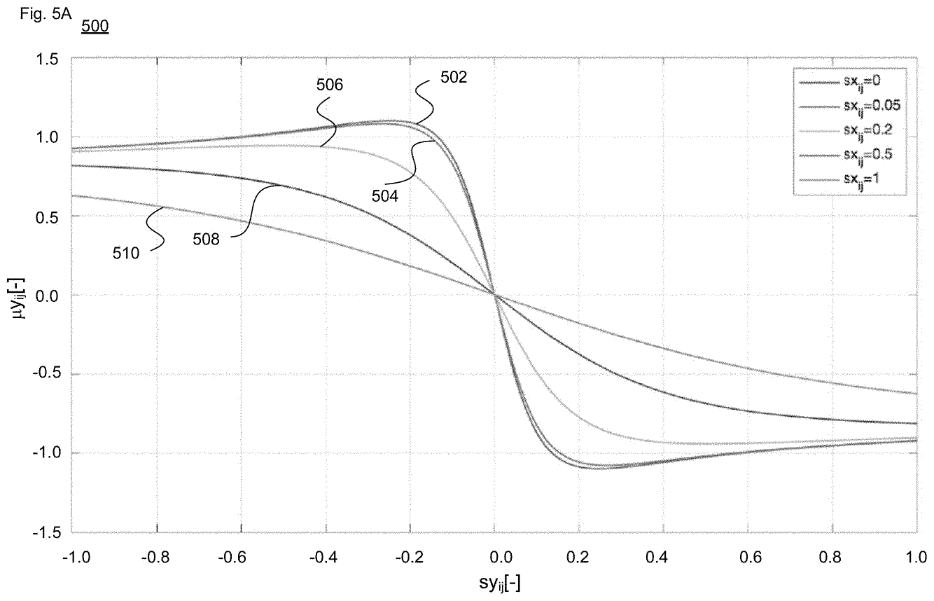

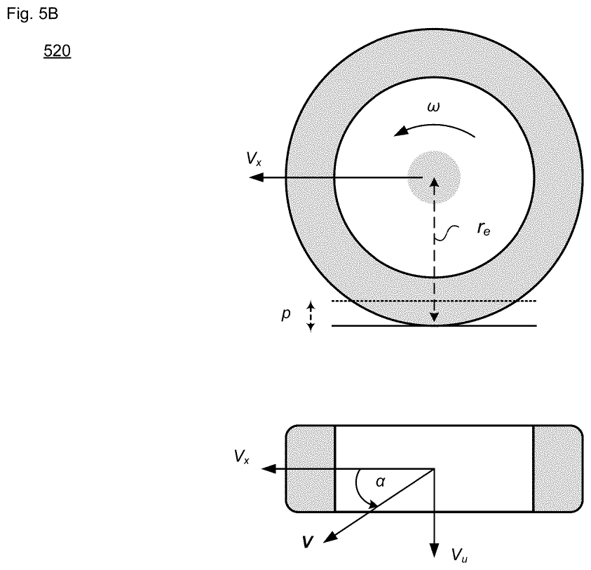

Information about the tires is according to the magic formula (e.g., magic formula 5.2/MF52 or equivalent). By way of example. FIG. 5A illustrates a chart 500 showing a magic formula example of lateral tire μyᵢⱼ as a function of lateral slip syᵢⱼ. Here, the plots 502, 504, 506, 508 and 510 illustrate results for longitudinal sxᵢⱼ slip values 0, 0.05, 0.2, 0.5 and 1, respectively. This example shows the effects of combined lateral and longitudinal forces. FIG. 5B illustrates side and top-down representations of an example tire in view 520. Here, rₑ is the effective rolling radius, p indicates vertical deflection, Vₓ, and V_{y} are longitudinal and lateral speed of the wheel center in an earth-fixes system, V is re resultant speed vector, and ω is the rim rotation speed. Given this, the slip angle α is: artcan(V_{y}/Vₓ). The lateral slip s_{y} is V_{y}/|Vₓ|. And the longitudinal slip sₓ=(Vₓ₋ω*rₑ)/Vₓ.

The model structure includes a steady state lateral force model with combined force constraints, in which increasing in magnitude longitudinal force could reduce in magnitude lateral forces. The tire model will support low speed aligning torque (simplified turn-slip effect from the tire characterization). And the longitudinal and lateral force stiffness (force gradient as a function of slip) will depend upon tire vertical, load. In addition, the tire model will allow emulation of mu transition by adapting the friction coefficient (μ scaling) per tire. Furthermore, the overall model architecture will include lateral force compliance. Tire forces to rack forces can be modeled using the tire self-aligning moment, steering arm length and scrub radius (variable mechanical trail), jacking effect, etc.

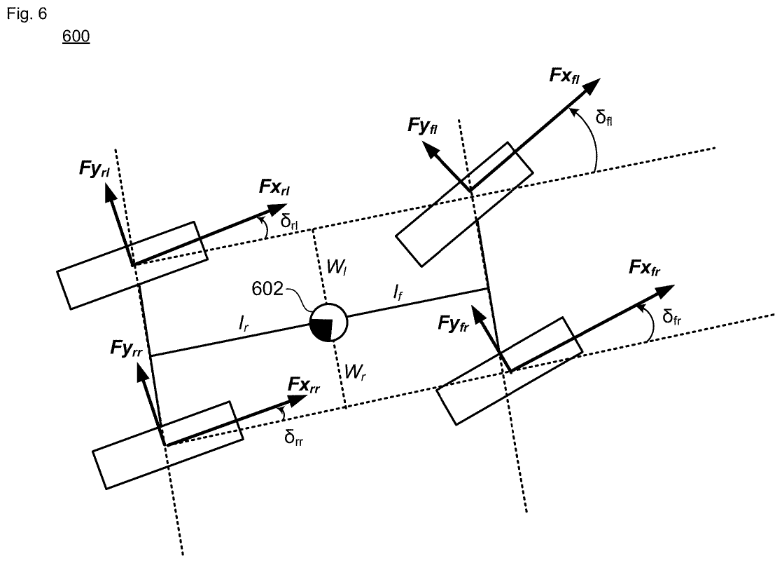

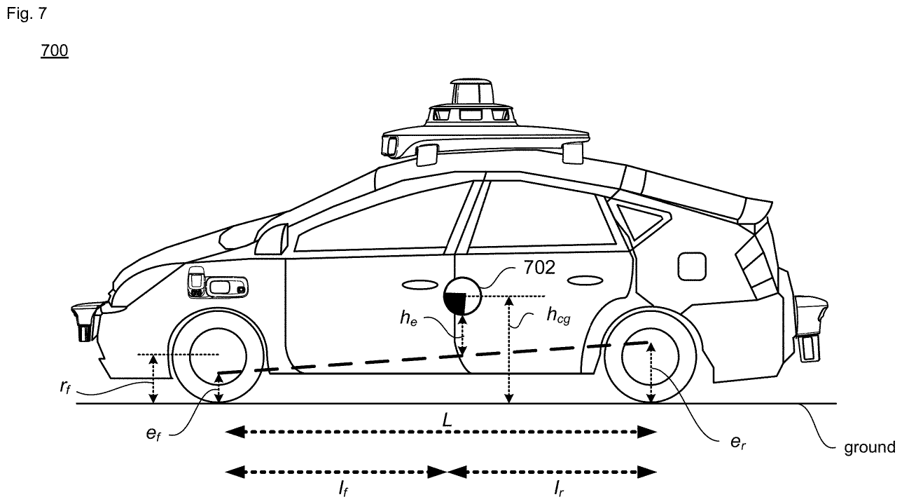

FIG. 6 illustrates an example vehicle body diagram 600, showing the tire longitudinal and lateral forces, Fxᵢⱼ and Fyᵢⱼ (in Newtons). Here, l_{f} and lᵣ are the distances from the vehicle center of gravity 602 to the front axle and rear axle, respectively (in meters). The distance of the right wheel to the axle's centerline is Wᵣ, and the distance of the left wheel to the axle's centerline is Wₗ (in meters). Note that the overall track width (Wₜᵣ) would be Wᵣ+Wₗ.

FIG. 7 illustrates an exemplary load transfer diagram 700, in which the vehicle has a center of gravity (CG) 702. Here, e_{f} and eᵣ indicate the height of roll center at the front roll axis and rear roll axis, respectively (in meters). h_{cg} indicates the height of the center of gravity from ground, while hₑ indicates the distance of the center of gravity from the roll axis (in meters). L is the vehicle's overall wheelbase (in meters), which equates to l_{f}+lᵣ. Here, rᵣ is the wheel loaded radius (after compression with vehicle's load), and r_{f} is the front wheel loaded radius.

Before illustrating vehicle system dynamic equations and steering system dynamic equations that can be used in the model architecture, the following tables identify what various symbols correspond to. Note that the steering system should behave in a quasi-linear manner within the defined performance boundaries.

TABLE 1
Vehicle System

| Symbol | Explanation | Units |
|---|---|---|
| M | Vehicle mass | kg |
| I₂ | Moment of inertia around the center of | kg * m² |
| | gravity (CG) | |
| l_{f}, lᵣ | Distance from vehicle GC to front axle, | m |
| | rear axle | |
| L | Vehicle wheelbase (l_{f} + lᵣ) | m |
| Wₗ, Wᵣ | Distance of the left, right wheel from the | m |
| | axle's centerline (half track width) | |
| Wₜᵣ | Track width (Wₗ + Wᵣ) | m |
| accₓ, acc_{y} | Vehicle longitudinal, lateral acceleration at | m/s² |
| | CG (body fixed coordinate) | |
| \dot{x}, \dot{y} | Vehicle longitudinal (Vₓ), lateral velocity | m/s² |
| | (V_{y}) at CG (body fixed coordinates) | |
| \dot{ψ} | Yaw rate (body fixed coordinates) | rad/s |
| X, Y, Ψ | Longitudinal & lateral position at CG, | m, m, |
| | yaw angle | rad |
| Fxᵢⱼ, Fyᵢⱼ | Tires longitudinal, lateral force for i: | N |
| | f (front) r (rear), j: l (left), r (right) wheel | |
| Vxᵢⱼ, Vyᵢⱼ | Tires longitudinal, lateral speed for i: | m/s |
| | f (front) r (rear), j: l (left), r (right) wheel | |
| sᵢⱼ, sxᵢⱼ, syᵢⱼ | Tires longitudinal, lateral slip for i: | ┤ |
| | f (front) r (rear), j: l (left), r (right) wheel | |
| h_{cg}, hₑ | Height of CG from ground, distance of | m |
| | CG from roll axis | |
| e_{f}, eᵣ | Height of roll center at the front, rear roll | m |
| | axis | |
| Fzᵢⱼ | Normal force for i: f (front) r (rear), | N |
| | j: l (left) r (right) wheel | |
| K_{f}, Kᵣ | Roll stiffness front, rear | $\frac{N \cdot m}{rad}$ |
| D_{Mf}, C_{Mf}, B_{Mf} | Simplified Magic Formula peak value factor | |
| | (D_{Mf}), shape factor (C_{Mf}) and stiffness | |
| | factor (B_{Mf}) | |

TABLE 2
Steering System

| Symbol | Explanation | Units |
|---|---|---|
| δᵢⱼ | Roadwheel angle for i: f (front) r (rear), j; l (left) r (right) | rad |
| | wheel | |
| Θ_{HW} = Φᵢₛₕ, Θₚ | Hand wheel angle = EPS input shaft angle, pinion angle | rad |
| torᵢₛₕ, tor_{driver}, | Torque input shaft, driver (external torque to the steering | Nm, Nm, Nm |
| torₘₒₜₒᵣ | wheel), EPS motor torque | |
| x_{rack} | Steering rack displacement | m |
| r_{Hw→rack} | Ratio relating hand wheel angle to rack translation (c-factor) | |
| r_{motor→rack} | Ratio relating EPS motor angle to rack translation | |
| J_{HW} | Hand wheel + steering column moment inertia about its | kg * m² |
| | steering axis | |
| tₘ(x_{rack}) | Mechanical trail length (scrub radius) as a function of rack | m |
| | displacement | |
| lₛ(x_{rack}) | Effective steering arm length as a function of rack | m |
| | displacement | |
| ls, lₛ^{avg} | Steering arm, average steering arm length over steering | m, m |
| | range considered | |
| F_{rackmech}, | Steering rack mechanical (force due to torsion bar), | N, N, N |
| F_{rackreact}, | reaction force (tire reaction forces and vehicle jacking | |
| F_{rackmotor} | effects), EPS motor force in rack coordinates | |
| m_{rack}, | Rack mass, front axle inertia referred to rack coordinate | kg, kg, kg, kg |
| m_{susp→rack,} | frame, EPS motor-transmission inertia referred to rack | |
| m_{motor→rack,} | coordinate frame, total mass referred to rack system | |
| m_{racktotal} | | |
| kᵢₛₕ, bᵢₛₕ | Input shaft (torsion bar) stiffness, damping | $\frac{N \cdot m}{rad} , \frac{N \cdot m}{rad / s}$ |
| b_{Hw}, torFr_{Hw} | Handwheel damping, handwheel friction torque emulation | $\frac{N \cdot m}{rad / s} , {N}_{rr}$ |
| b_{rack}, FFr_{rack} | Rack damping, rack friction torque emulation | $\frac{N}{m / s} , N$ |
| torWhTotᵢⱼ, | Total aligning torque per wheel induced by the tire's | Nm |
| torWhPnᵢⱼ, | moment due to its pneumatic properties (self-aligning) + | |
| torWhMechᵢⱼ | torque due to the suspension design (mechanical | |
| | trail/scrub) for the i: f (front) r (rear), j: l (left) r (right) wheel | |

As shown in table 3 below, the following vehicle system dynamic equations may be employed in accordance with the model architecture. Regarding the tire model equations 13-16, these are a simplified reference of the magic formula that may be used.

TABLE 3
Vehicle System Dynamic Equations

| | |
|---|---|
| accₓ = \ddot{x} − \dot{ψ} · \dot{y} | eq. 1 |
| acc_{y} = ÿ +\dot{ψ} · \dot{x} | eq. 2 |
| m · accₓ = Fx_{fl} · cos(δ_{ft}) + Fx_{fr} · cos(δ_{fr}) + Fxᵣₜ · cos(δᵣₜ) + | eq. 3 |
| Fxᵣᵣ · cos(δᵣᵣ) + − [Fy_{fl} · sin(δ_{ft}) + Fy_{fr} · sin(δ_{fr}) + Fyᵣₜ · | |
| sin(δᵣₜ) + Fyᵣᵣ · sin(δᵣᵣ)] −1/2 ρ · A · C_{d} · | |
| m · acc_{y} = Fx_{fl} · sin(δ_{ft}) + Fx_{fr} · sin(δ_{fr}) + Fxᵣₜ · sin(δᵣₜ) + | eq. 4 |
| Fxᵣᵣ · sin(δᵣᵣ) + + [Fy_{fl} · cos(δ_{ft}) + Fy_{fr} · cos(δ_{fr}) + Fyᵣₜ · | |
| cos(δᵣₜ) + Fyᵣᵣ · cos(δᵣᵣ)] | |
| lₛ · \dot{ψ} = Wₜ · [− Fx_{ft} · cos(δ_{ft}) + Fy_{ft} · sin(δ_{ft})] + l_{f} · [Fx_{ft} · | eq. 5 |
| sin(δ_{ft}) + fy_{fl} · cos(δ_{ft} [symbol] Wᵣ · [Fx_{fr} · cos(δ_{fr}) − Fy_{fr} · | |
| sin(δ_{fr})] + l_{f} · [Fx_{fr} · sin(δ_{fr}) + Fy_{fr} · cos(δ_{fr})] + Wₗ · | |
| [− Fxᵣₜ · cos(δᵣₗ) + Fyᵣₜ · sin(δᵣₗ)] + lᵣ · [− Fxᵣₗ · sin(δᵣₜ) − | |
| Fyᵣₜ · cos(δᵣₜ)] + Wᵣ · [Fxᵣᵣ · cos(δᵣᵣ) − Fyᵣᵣ · sin(δᵣᵣ)] + lᵣ · | |
| [− Fxᵣᵣ · sin(δᵣᵣ) − Fyᵣᵣ · cos(δᵣᵣ)] | |
| ${Fz}_{ft} = \frac{m \cdot g \cdot {t}_{r} \cdot {W}_{r}}{L \cdot {W}_{ir}} - \frac{m \cdot {h}_{eg} \cdot {W}_{r}}{L \cdot {W}_{cc}} {acc}_{x} + \frac{m}{{W}_{u}} {G}_{front} \cdot {acc}_{y}$ | eq. 6 |
| ${Fz}_{fr} = \frac{m \cdot g \cdot {t}_{r} \cdot {W}_{t}}{L \cdot {W}_{a}} - \frac{m \cdot {h}_{rg} \cdot {W}_{t}}{L \cdot {W}_{a}} {acc}_{x} + \frac{m}{{W}_{u}} {G}_{front} \cdot {acc}_{y}$ | eq. 7 |
| ${Fz}_{rt} = \frac{m \cdot g \cdot {t}_{r} \cdot {W}_{c}}{L \cdot {W}_{a}} + \frac{m \cdot {h}_{cg} \cdot {W}_{c}}{L \cdot {W}_{rr}} {acc}_{x} - \frac{m}{{W}_{u}} {G}_{rear} \cdot {acc}_{y}$ | eq. 8 |
| ${Fz}_{rr} = \frac{m \cdot g \cdot {t}_{f} \cdot {W}_{t}}{L \cdot {W}_{a}} + \frac{m \cdot {h}_{cg} \cdot {W}_{t}}{L \cdot {W}_{u}} {acc}_{x} + \frac{m}{{W}_{u}} {G}_{rear} \cdot {acc}_{y}$ | eq. 9 |
| ${h}_{g} = {h}_{cg} - \frac{{t}_{f} \cdot {ε}_{r} + {l}_{r} \cdot {ϵ}_{f}}{L}$ | eq. 10 |
| ${G}_{front} = \frac{{h}_{e} \cdot {K}_{f}}{{K}_{t} + {K}_{t} - m \cdot g \cdot {h}_{x}} + \frac{{t}_{c}}{L} {e}_{f}$ | eq. 11 |
| ${G}_{rear} = \frac{{h}_{e} \cdot {K}_{f}}{{K}_{f} + K \text{?} - m \cdot g \cdot h \text{?}} + \frac{{t}_{t}}{L} {e}_{f}$ | eq. 12 |
| $\begin{matrix}{sx}_{ij} = \frac{Vx \text{?} - {ω}_{a} r \text{?}}{{ω}_{ij} \cdot {t}_{t}} , {sy}_{ij} = \frac{Vy \text{?}}{ω \text{?}} \\ ij\end{matrix}$ | eq. 13 |
| sᵢⱼ = \sqrt{sxᵢⱼ² + syᵢⱼ²} | eq. 14 |
| μᵢⱼ = D_{Mf} · sin(C_{Mf} · tan⁻¹(B_{Mf} · sᵢⱼ)) | eq. 15 |
| ${μx}_{ij} = - \frac{{sx}_{ij}}{{s}_{ij}} {μ}_{ij} \cdot μ {y}_{ij} = - \frac{{sy}_{ij}}{{s}_{ij}} {μ}_{ij}$ | eq. 16 |

[symbol]

indicates data missing or illegible when filed

As shown in table 4 below, the following steering system dynamic equations may be employed in accordance with the model architecture.

TABLE 4
Steering System Dynamic Equations

| | |
|---|---|
| J_{Hw} · θ̅_{Hw} = tor_{Driver} − \dot{θ}_{Hw} · b_{Hw} − torFr_{Hw} − (θ_{Hw} − θₚ) · | eq. 21 |
| kₗₛₕ − (\dot{θ}_{Hw} − θₚ) · bₗₛₕ | |
| torₗₛₕ = (θ_{Hw} − θₚ) · kₗₛₕ + (\dot{θ}_{Hw} − \dot{θ}ₚ) · bₗₛₕ | eq. 22 |
| m_{RackTotal} · \ddot{x}_{Rack} = F_{RackMech} + F_{RackMotor} − \dot{x}_{Rack} · b_{Rack} − | eq. 23 |
| F_{RackReact} − FFr_{Rack} | |
| F_{RackMotor} = tor_{Motor} · r_{Motor→Rack} | eq. 24 |
| F_{RackMech} = torᵢₛₕ · r_{Hw→Rack} | eq. 25 |
| ${F}_{RackReact} = \frac{{torWhTot}_{ft}}{{f}_{cfr} ( {x}_{rack} )} + \frac{{torWhTot}_{fr}}{{t}_{ifr} ( {x}_{rack} )}$ | eq. 26 |
| torWhTotᵢⱼ = torWhPnᵢⱼ + torWhMechᵢⱼ | eq. 27 |
| FFr_{Rack} = Function(\dot{x}_{Rack}) | eq. 28 |
| torPr_{Hw} = Function(\dot{θ}_{Hw}) | eq. 29 |

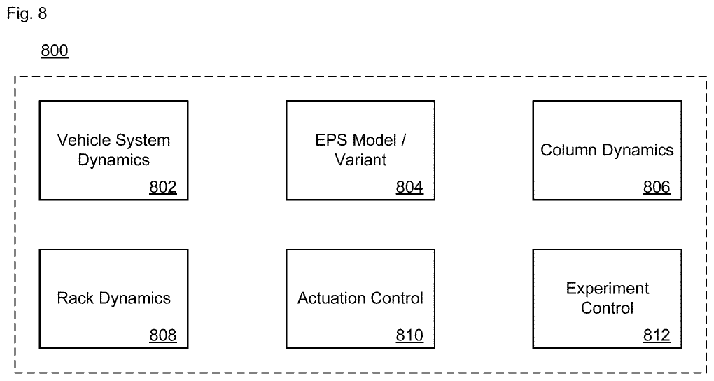

FIG. 8 illustrates a block diagram 800 of an example model structure in accordance with the technology discussed herein. In this example, the model structure includes certain blocks or modules, including a vehicle system dynamics block 802, an EPS model/variant block 804, a column dynamics block 806, a rack dynamics block 808, an actuation control block 810, and an experiment control block 812. In another example, the model structure may also include an EPS log block for EPS-related signal collection. In other examples, one or more of these blocks may be omitted from the model structure. Implementing the model structure in a virtual testing environment can include logging selected data, generating plots/charts for display, receiving input to adjust parameters for evaluation, etc.

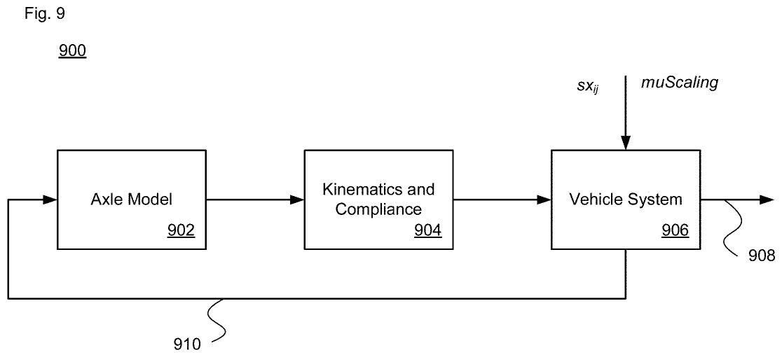

The vehicle system dynamics block 802 contains the vehicle planar dynamics and rack reaction forces. In one scenario, this block encompasses the vehicle system, kinematics and compliance, the axle model, and body vehicle movement. The vehicle system involves chassis/dynamics equations. Kinematics and compliance are used to estimate the final road wheel angles for all wheels. The axle model estimates the rack reaction forces subject to the vehicle states and the effective wheels aligning moment around the z-axis. The body vehicle movement translates the vehicle states to global coordinates. For instance, as shown in block diagram 900 of FIG. 9, axle model 902 calculates the wheels aligning moment around the z-axis. For example, this can include calculating the front tires total aligning torque, the rear tires total aligning torque and the jacking torque, and also calculating the rack reaction force using the front wheels total aligning torque multiplying with the appropriate steering arm length.

This information from block 902 is provided to kinematics and compliance block 904, which calculates the road wheel (tire) angle. The output from block 904 (delta, the tire angle) is provided to vehicle system block 906, which also receives mu scaling and sxᵢⱼ (slip) inputs. The vehicle system block 906 outputs vehicle state information 908, e.g., body-chassis translation and angular positions, acceleration, etc. Feedback loop 910 provides the tires' longitudinal and lateral forces, and self-aligning torque around the z-axis back to the axle model block 902.

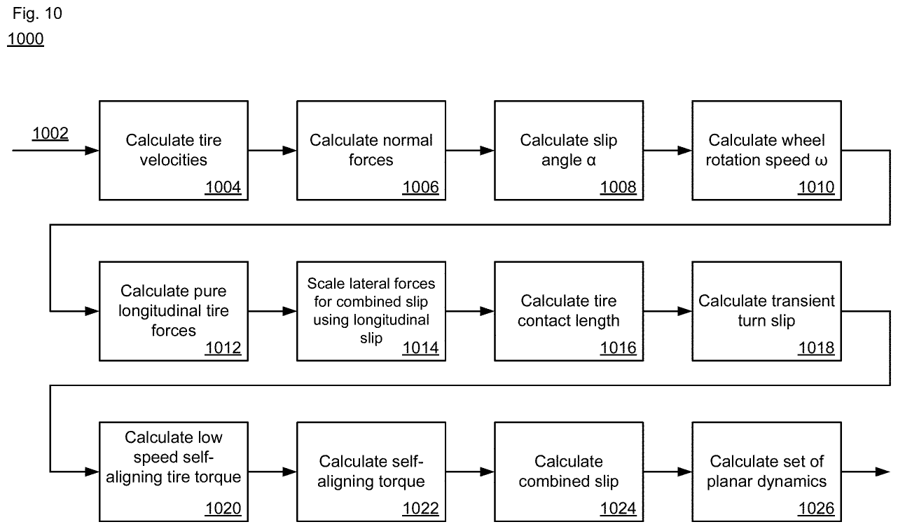

FIG. 10 illustrates a flow diagram 1000 for a planar dynamics module of the vehicle system dynamics. At 1002, the module receives various inputs, such as planar states, the delta from block 904, mu scaling information (scaling for the friction coefficient per tire), vehicle parameters (e.g., tires, dimensions), etc. At block 1004, the system calculates tire velocities from the body-chassis frame. Then at block 1006, the system calculates normal Fzᵢⱼ forces (by way of example, Fz_{fl}=(mass*g*lᵣ*_{wr})/(L*wₜᵣ)−(mass*h_{CG}*wᵣ)/(L*wₜᵣ)*acc−(mass*G_{front}/wₜᵣ)*acc_{y})). At block 1008, the system sets a minimum longitudinal speed to avoid numerical instabilities and calculates slip angle α. Then at block 1010, the system calculates the wheel rotational speed ω from the slip input according to normal load variation. At block 1012, the system calculates pure longitudinal tire forces using, slip. At block 1014, the system uses the lateral slip angle to first calculate pure lateral forces. Then, using the longitudinal slip, the system scales the pure lateral forces to get the lateral forces for combined slip. At block 1016, the system calculates the tire contact length. At block 1018, the system calculates the transient behavior of the turn slip for only the front wheels.

At block 1020, the system calculates low speed (e.g., for parking) self-aligning tire torque. This can be accomplished as follows. First, calculate the transient behavior of the turn slip. Then calculate the peak parking torque the tire can deliver subject to inflation pressure p0, friction coefficient muSc, and normal load Fz, scaled with the longitudinal tire speed Vx. Then calculate (e.g., using a hysteresis model for parking) torque stiffness. Then calculate the speed Vx and mu scaled “damping” torque function of the turn slip, and then calculate the final (parking) torque.

At block 1022, the system calculates the self-aligning torque first for pure sideslip and then at block 1024 it calculates the combined slip. At block 1026, the system calculates a set of planar dynamics equations (e.g., equations 3, 4 and 5 above), which are then output for use by other system modules. For instance, the forces calculated in equations. 3-5 are used to solve for \ddot{x}, ÿ and \ddot{ψ}. These derivatives can be integrated to derive \ddot{x}, ÿ and \ddot{ψ}.

Returning to FIG. 8, the EPS model/variant block 804 can be used for a SIL model and functional EPS assist and angle control. By way of example, this block may be employed to emulate an EPS controller that contains a torque controller (e.g., basic steering assist for manual driving and angle control), driver override logic (e.g., driver arbitration and takeover functionality), torsion bar transmission information, and a variable steering ratio (e.g., to emulate the variable transmission ratio rack). For instance, driver override logic checks for driver intervention through the torsion bar torque (e.g., how much time the driver's steering torque, torqueISH, has been above a certain threshold) and the EPS engage mode and determines whether there is a need to trigger a driver override condition by checking the steering torque persistency.

There may be imposed motor torque limits from either physical or control limits (e.g., thermal protection, etc.). A torque blending timer can be employed to blend the driver torque and the angle controller torque for smooth transition. The torque controller is configured to determine a torque motor out command, which is sent to the EPS motor. The torque is either from the driver's steering torque (torqueISH) going through some kind of amplification logic (e.g., a boost curve from a lookup table) or from an EPS angle controller that gets as input the angle error and generates a target torque that would minimize that error. The controller may be a PID structure or other type of controller. The output of the angle controller PID or the lookup table can be blended together subject to a blend signal that gradually ramps-in-out the one torque vs the other according whether the angle controller is enabled or not. A torque motor request can be saturated by the physical torque motor limit and a damping component function of the EPS speed, is removed from the request. A soft rack end stop lookup table may be used to limit the boost torque when approaching the mechanical rack limits.

The column dynamics block 806 is associated with a set of steering parameters. This can be modeled as a second order system with inertia J_{HW} damping and friction. The steering parameters may include one or more of: a steering rack mass and friction parameter, mechanical properties of the steering column, torsion bar parameters (e.g., torᵢₛₕ) and/or the EPS transmission ratio for pinion and motor transmission. For the steering rack mass and friction, a high value emulates the referred inertia of the EPS motor in rack coordinates. The mechanical properties of the steering column may include inertia and friction emulated as a hyperbolic function with peak friction torque.

During evaluation, when the rack position reaches a maximum value, it will control the speed integration. In principle, what happens in the physical world is that the rack stops moving even further because it starts to compress against the endstop. This mechanical impact is a “stiff” system for numerical solution. Thus, in one example this mechanism-method can emulate the fact that rack has reached its endstop. In this example, input shaft speed and rack speed are controlled together at the same instance to avoid a damping torque spike.

The rack dynamics block 808 employs one or more parameters and functions. For instance, in this block the system may sum f_{rack} (motor+driver) and f_{rod} (reaction) force parameters over the mass of the rack to derive an acceleration value. The mass of the rack can have the referred inertia of the EPS and/or the suspension added to it. One function employed in this block simulates a rack endstop (e.g., for use by the column dynamics block). Another function allows to blend simulated and logged rack position/rate. For instance, the system can impose [==1] or not [==0] the rack dynamics. Effectively, this imposes the logged rack position and speed instead of using the output of the rack dynamics model. This enables state blending as well as decoupling the EPS model behavior for pure vehicle-chassis dynamics verification. With regard to blending, this allows [==1] or not [==0] to use the logged position before enabling rack position control. Thus, when ==1 the system can start a simulation from manual drive during a manual driving mode and when EPS goes to a partially autonomous mode with driver takeover it allows the rack dynamics of the simulated EPS variant to propagate as outputs (xRack[m] and \dot{x}Rack[m/s]).

The actuation control block 810 controls wheel longitudinal slip sxᵢⱼ. Example inputs to this block include vehicle state information, speed target information (received from the experiment control block 812) and mu scaling information (received from the experiment control block 812). The output from this block includes longitudinal slip information sxᵢⱼ. In one scenario, the actuation control block 810 is able to estimate long acceleration with initial conditions and/or slip target function. For instance, estimating long acceleration with initial conditions may take xDotTarget (\dot{x}Target) as an input, and outputs the estimated chassis acceleration (xDotDotTargetEst, \ddot{x}TargetEst) that would effectively yield the target speed. By way example, based on the input, a second order filtered estimate is produced for the acceleration. This allows setup of the initial condition of the filter so that longitudinal speed target and longitudinal acceleration target correspondingly. The \ddot{x}TargetEst is a controller derivative of the \dot{x}Target that allows initial conditions for the filtering. So, by way of example, if the target speed is 10 m/s and the system starts at 10 m/s, then \ddot{x}TargetEst is already 0 m/s². If the block did not do this initial condition control, then there could be spikes in the acceleration during simulation initialization.

In one example with a 4-wheeled vehicle, the actuation control block may perform the following functions. First, calculate total normal force for all 4 wheels (Fzₜₒₜₐₗ=(Fz_{fl}+Fz_{fr}+Fzᵣₗ+Fzᵣᵣ)). Then, allocate the forceFxTarget to all 4 tires according to Fxᵢⱼ=forcesFxTarget*Fz_{fl}/Fzₜₒₜₐₗ. Effectively, this allocates how much of the total longitudinal force (forcexTarget) an individual tire should generate. The tires with higher normal loading are expected to get higher force allocation. Thus, in a rear-wheel-drive architecture, the rear wheels in acceleration would have higher normal force and they would get a bigger percentage. Next, using the tire parameters and magic formula (e.g., MF62), find the longitudinal slip that will result that desired longitudinal tire force and solve for the MF62 tire formulas. For example, subject to the normal load and the target force per tire (e.g., 10,000 N), from the tire curves that the magic formula generates, select the correct slip target value. Thus, in one scenario, if the normal load was 48 kN, the slip ratio would be on the order of 0.02, while if the normal load was 13.7 kN, then the slip ratio would be approximately 0.09. Next, the resulting slip should be limited to leave lateral forces for steering, by not allowing them to be greater than a selected value sxMaxⱼⱼ. This effective emulates a Traction Control System (TCS) and Antilock Braking System (ABS).

The experiment control block 812 implements simulations. It is able to handle the driving mode (e.g., manual, a partially autonomous configuration with driver takeover, or a fully autonomous configuration with no driver takeover), mu scaling for changes to the friction coefficient to the tires, and a speed target. Inputs to the experiment control block 812 include vehicle state information and xDotRack data (m/s). Outputs from this block can include one or more of a mode requirement, a rack position requirement, a speed target, mu scaling per wheel (which changes the friction coefficient to the tires), a tor_{driver} value, as well as other outputs.

Various operational aspects of the model make it particularly beneficial for virtual validation and verification of the EPS subsystem and other components and modules that may be employed with a vehicle configured to operate in a fully or partially autonomous driving mode.

By way of example, the model can receive external input for a longitudinal speed target. The target speed will result to an acceleration target, and using the vehicle mass it will become a vehicle level force target. In this case, the acceleration target can be rate limited and delayed to emulate the dynamical effects-limitations of the actuators. The speed control can have a feedforward (related to vehicle mass and road grade) and feedback part. And a vehicle level force target can be allocated to the wheels as either propulsion or braking torque in the form of longitudinal slip sxᵢⱼ.

In another example the model may be used to mock-up stability control, including longitudinal slip control and vehicle yaw rate control. For instance, a longitudinal slip controller module can effectively use the tire model properties to ensure that the vehicle retains steerability (e.g., in order to retain 50%). By way of example, a slip ratio should be selected that under all conditions would allow the system to maintain, at minimum 50%, of the lateral forces the tire can develop. The controller can operate as target longitudinal slip (sxᵢⱼ) saturation. Here, it would not be a feedback controller. Vehicle yaw rate control would actuate on the brakes. In this scenario, both a longitudinal slip and yaw rate control could be enabled or disabled at-will.

Parameter variation can also be used to modify aspects of the model. For instance, a set of scripts may be provided to enable parameter variations with physical sense: e.g., loading condition cases that will influence the overall vehicle mass and CG location but will also have an effect on the related physical properties such as the yaw moment of inertia, height of center of gravity, etc. This can be very helpful for evaluating loading configurations, tires change effects, front/rear roll stiffness. External inputs to the model can include logged rack force disturbances.

### Model Validation

The model can be initially configured according to a set of operational requirements, for instance based on a vehicle type including a particular mass, occupant loading, center of gravity, tire pressure as per a cold nominal setpoint (for front and/or rear tires), etc. The model may also include a set of specific maneuver definitions, which may include one or more of the following:
Sine steer
Ramp steer
Step steer
Parking effort: e.g., steering ramp rate lock-2-lock at [0 and 5]*1.61/3.6 m/s, where lock-2-lock is moving the steering rack through its full range of motion/travel, e.g., full steering to the left and then full steering to the right.
Static steering kinematic properties; physical vs virtual kinematics and compliance
Suspension inertia identification; open loop frequency sweep on turn plates (or similar)
Suspension jacking effects; slow ramp steer on turn plates (or similar)

The model architecture provides channels to compare vs physical/experimental data. This can include evaluating (i) front road wheel angles (δᵢⱼ) vs hand wheel angle (θ_{Hw}) vs rack displacement (x_{rack}); (ii) lateral acceleration (acc_{y}) and longitudinal acceleration (accₓ); (iii) Yaw rate (\dot{ψ}); (iv) rack force estimate when relevant for the maneuvers from either rack force transducers or rack force estimate of the EPS; and (v) vehicle level propulsion and braking torque (and maybe individual wheel brake pressure) subject to a fixed effective rolling radius rᵢ.

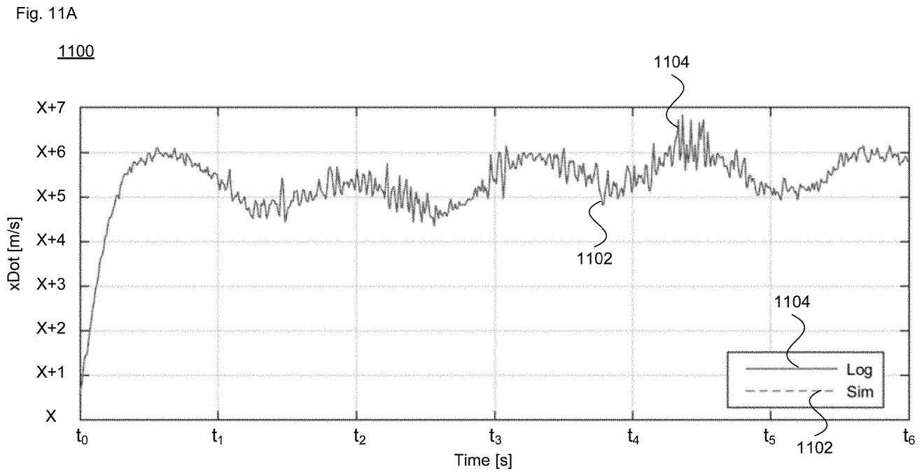

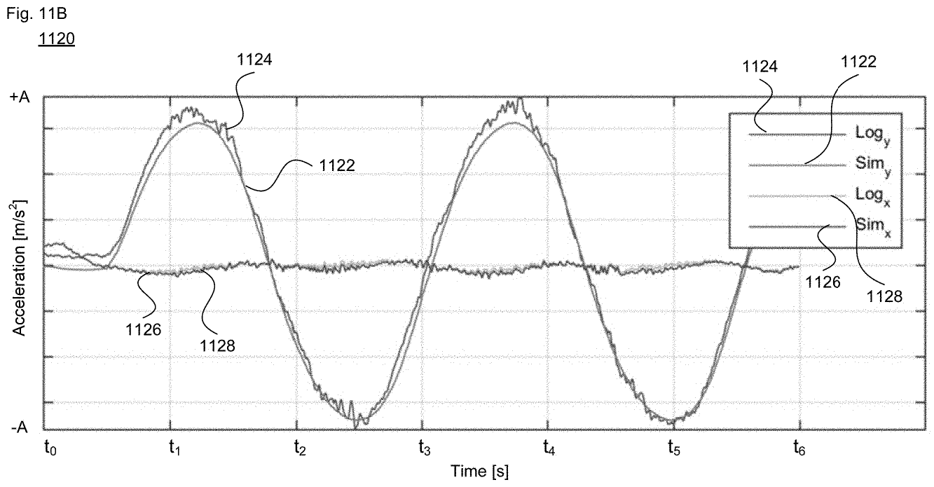

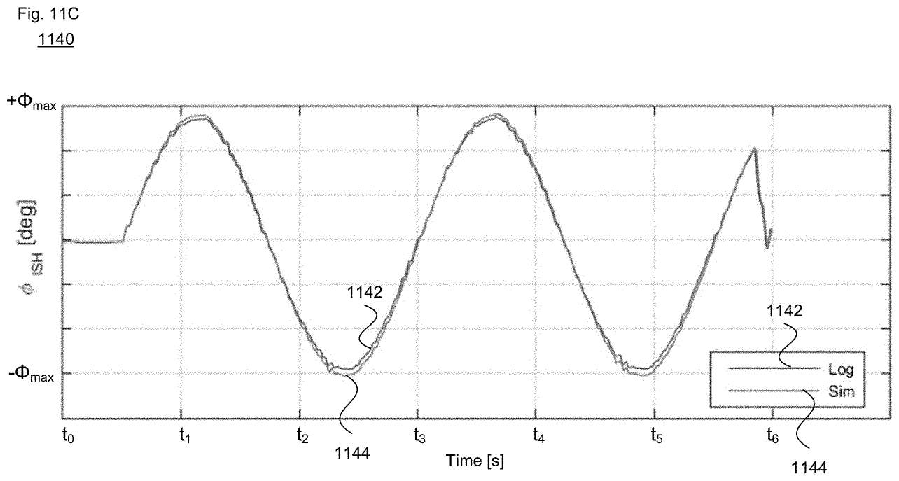

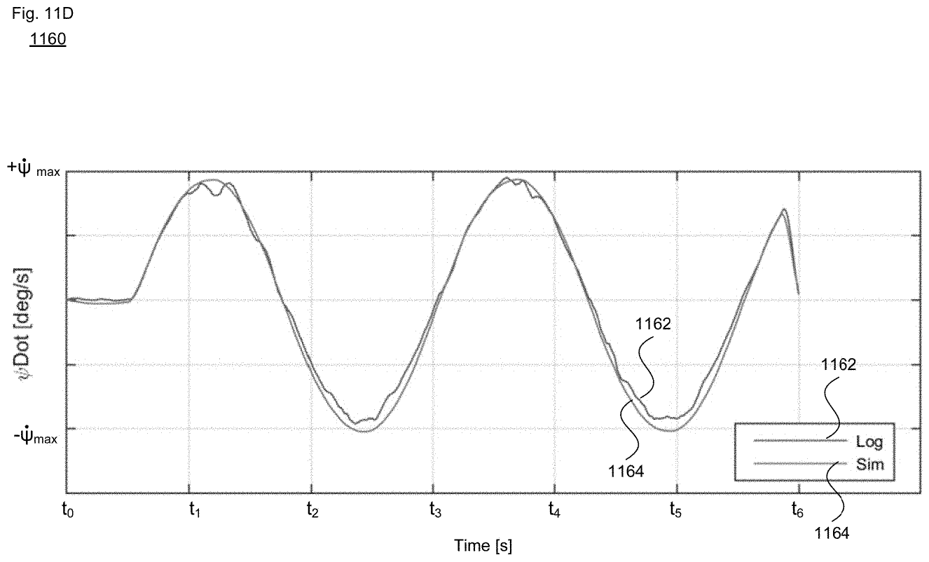

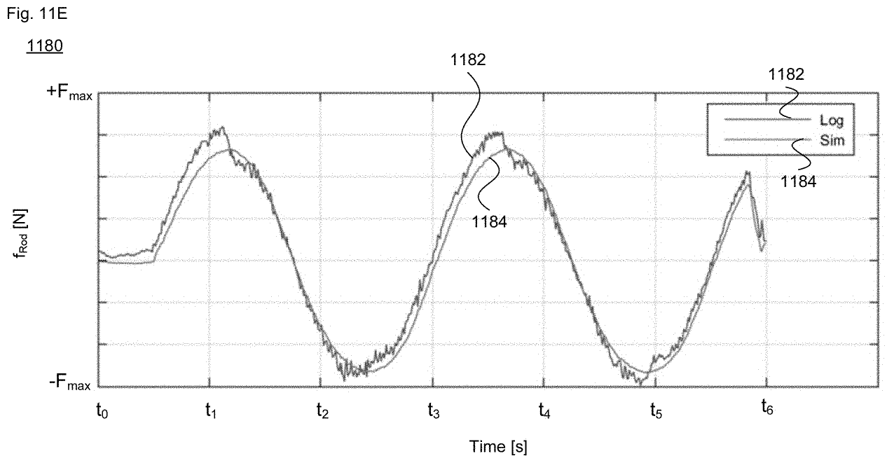

Validation may be performed by comparing simulation data obtained from the model with experimental log data. For example, FIGS. 11A-E are validation examples for a sine steer scenario with parameters on the order of 6 m/s² at approximately 20 m/s (45 mph). Speed chart 1100 of FIG. 11A compares simulation data 1102 against log data 1104 between time t₀ and t₆ within a speed range of X to X+7. As can be seen, the simulation data 1102 clearly aligns with the log data 1104. Acceleration chart 1120 of FIG. 11B compares lateral simulation data 1122 against lateral log data 1124, and longitudinal simulation data 1126 against longitudinal log data 1128, both along an acceleration range (−A to A) and between time t₀ and t₆. As shown in this example, the longitudinal (x-axis) acceleration simulation data very closely tracks the log data, while the lateral (y-axis) acceleration simulation data has minor discrepancies from the log data at maxima along, the sine wave (e.g., close to +A m/s). Input shaft angle chart 1140 of FIG. 11C compares log data 1142 against simulation data 1144, along an angle range −Φₘₐₓ to +Φₘₐₓ and between time t₀ and t₆. Yaw rate (ψDot) chart 1160 of FIG. 11D compares log data 1162 against simulation data 1164, along a range −\dot{ψ}ₘₐₓ to +\dot{ψ}ₘₐₓ and between time t₀ and t₆. And chart 1180 of FIG. 11E compares the reaction force between log data 1182 and simulation data 1184, along a range −Fₘₐₓ to +Fₘₐₓ and between time t₀ and t₆.

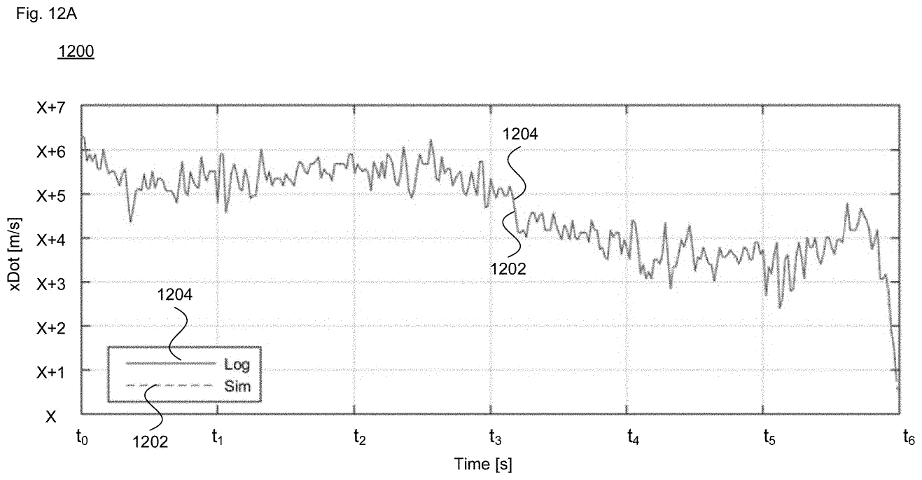

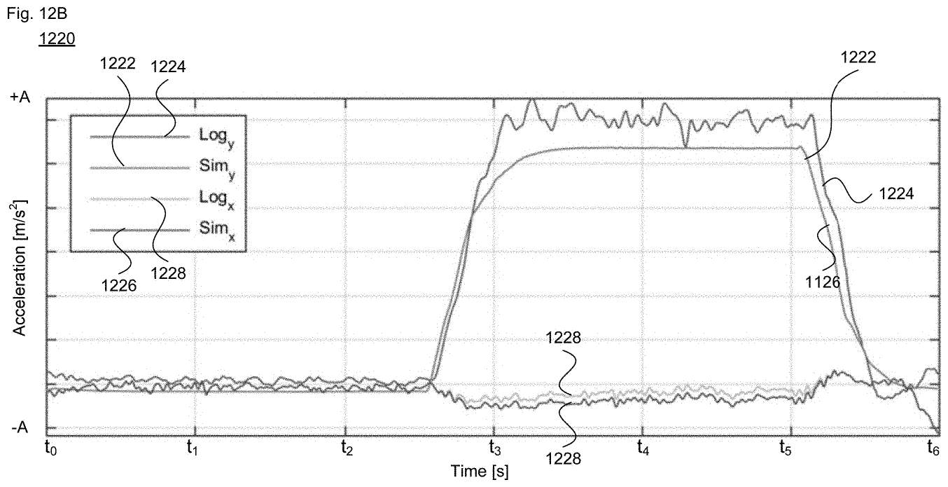

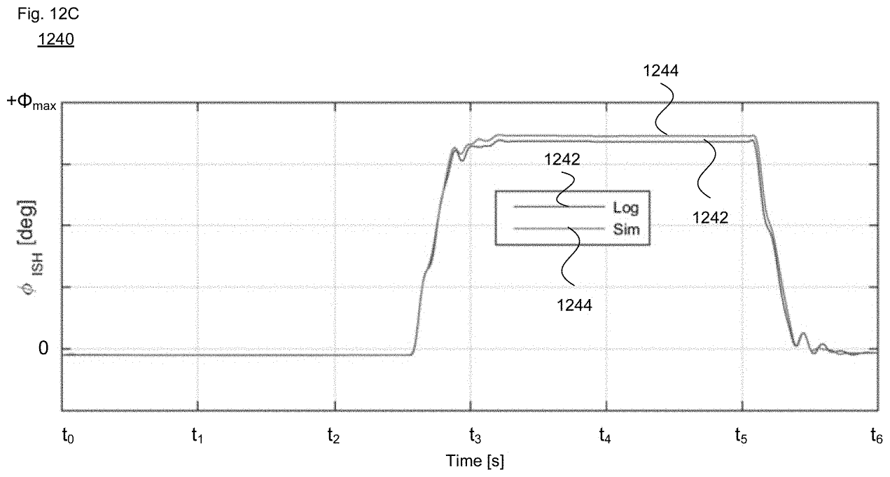

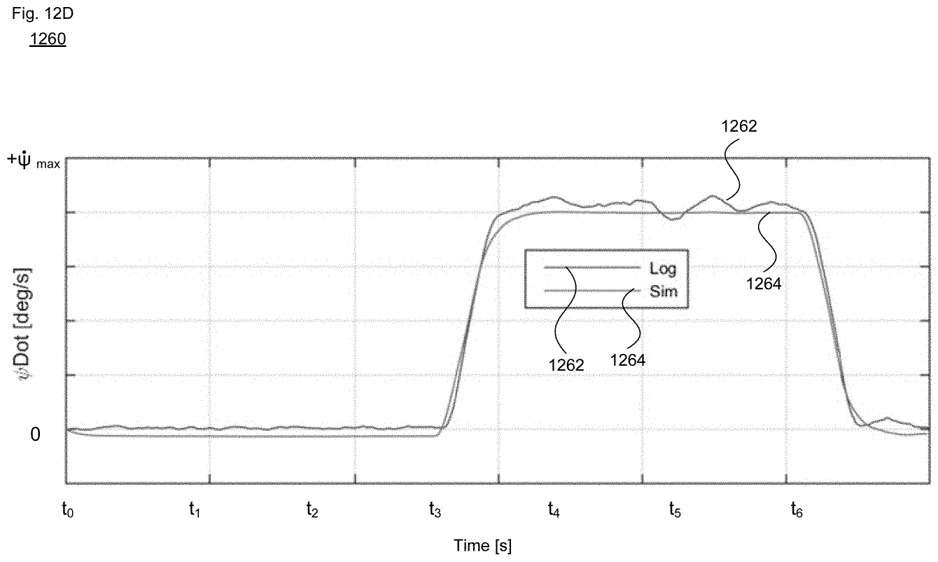

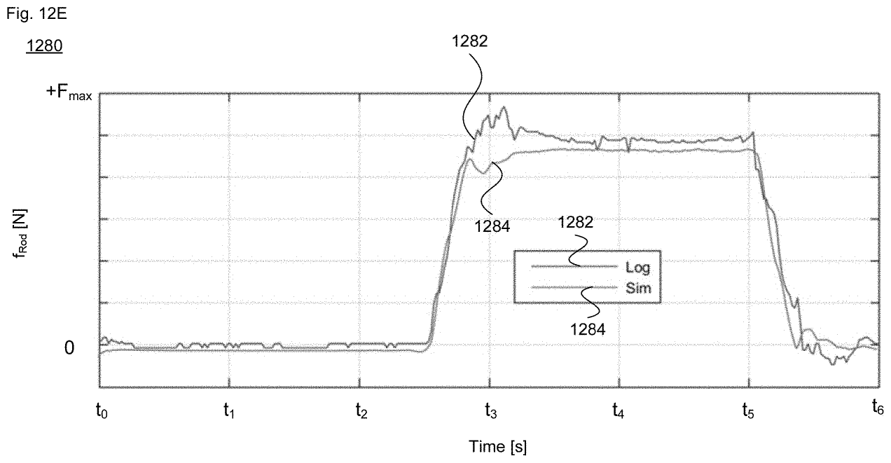

FIGS. 12A-E are validation examples for a step steer scenario with parameters on the order of 6 m/s² at approximately 15.5 m/s (35 mph). Speed chart 1200 of FIG. 12A compares simulation data 1202 against log data 1204 between time t₀ and t₆ within a speed range of X to X+7. Acceleration chart 1220 of FIG. 12B compares lateral simulation data 1222 against lateral log data 1224, and longitudinal simulation data 1226 against longitudinal log data 1128, both along an acceleration range (−A to A) and between time t₀ and t₆. Input shaft angle chart 1240 of FIG. 12C compares log data 1242 against simulation data 1244, along an angle range of about 0 to +Φₘₐₓ and between time t₀ and t₆. Yaw rate (ψDot) chart 1260 of FIG. 12D compares log data 1262 against simulation data 1264, along a range −Fₘₐₓ to +Fₘₐₓ and between time t₀ and t₆. And chart 1280 of FIG. 12E compares the reaction force between log data 1282 and simulation data 1284, along a range of about 0 to +Fₘₐₓ and between time t₀ and t₆.

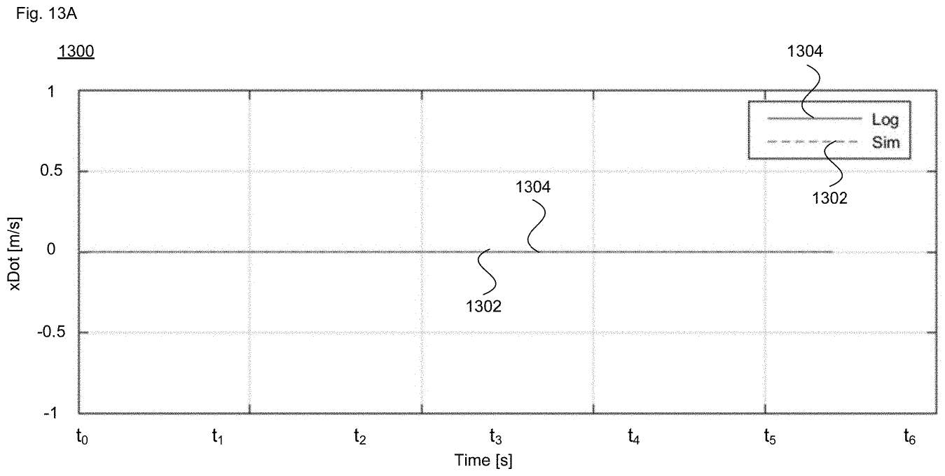

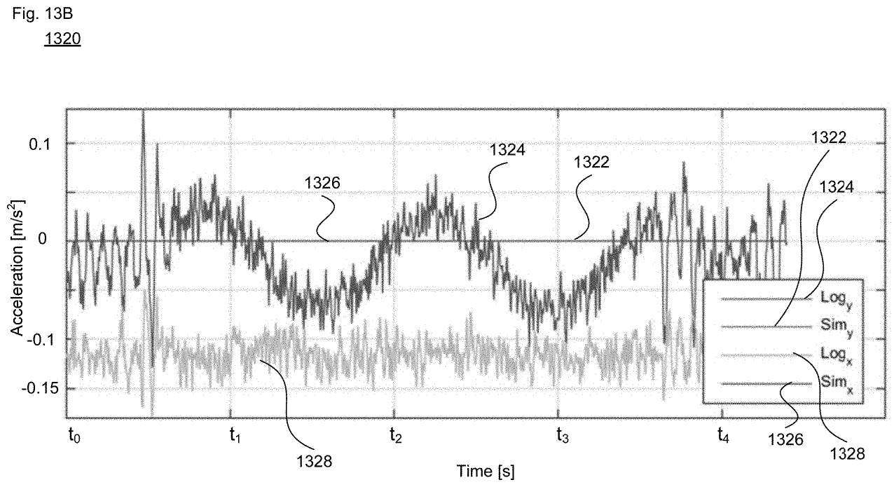

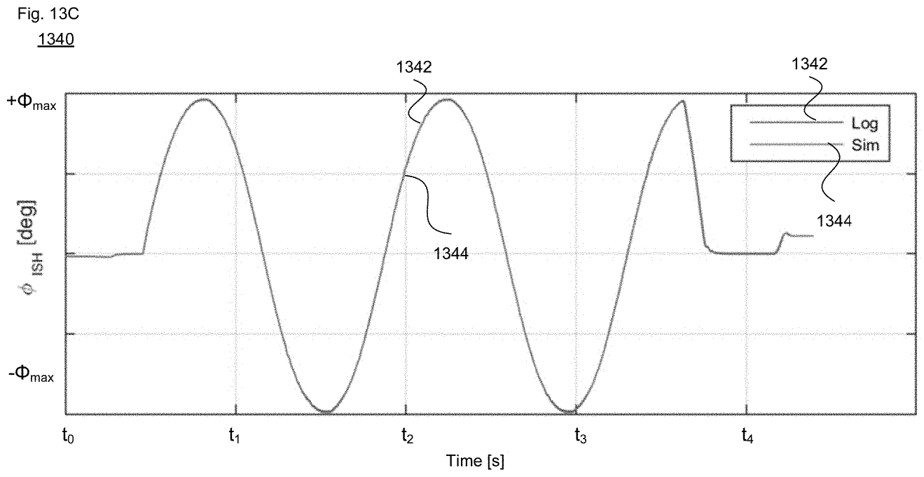

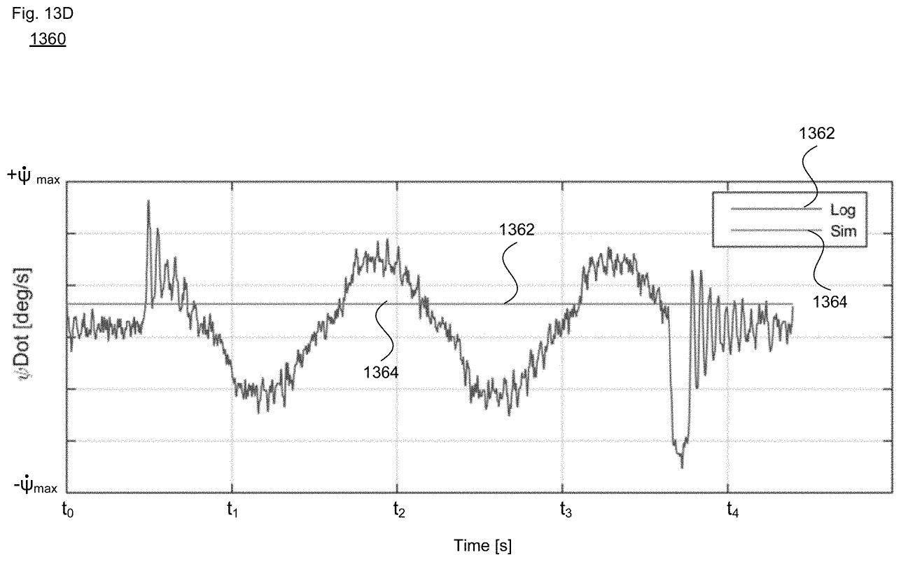

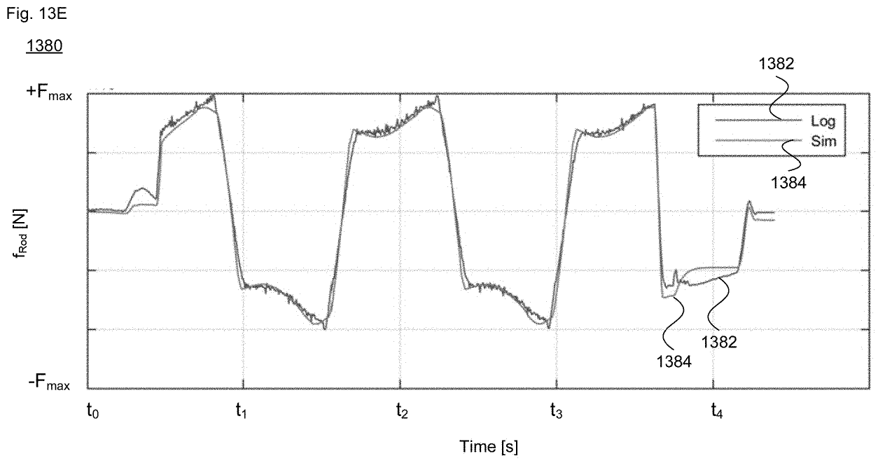

The verification model may be used, by engineers or third parties to validate EPS and/or other aspects of a vehicle chassis control systems, such as powertrain and brakes with stability control systems, configured to operate in a full or partially autonomous driving mode. Validation may be performed according to a model validation envelope or other criteria for specific tests. For instance, this could, include a model validation envelope for pure lateral tests, where factors such as ramp steer, sine steer or step steer could be considered. Another example is a model validation envelope on combined lateral-longitudinal tests. 100801 Other validation scenarios include parking (e.g., little to no speed or a minimal rolling speed on the order of about 2 mph), a combined longitudinal and lateral test course (e.g., evaluating U-turns, S-turns, accelerating J-turns, decelerating J-turns, etc.) For instance, FIGS. 13A-E are validation examples for a sine steer scenario with a speed of approximately 0 m/s (0 mph). Speed chart 1300 of FIG. 13A compares simulation data 1302 against log data 1304 between time t₀ and t₆. Acceleration chart 1320 of FIG. 13B compares lateral simulation data 1322 against lateral log data 1324, and longitudinal simulation data 1326 against longitudinal log data 1328, both along an acceleration range substantially on the order of 0 m/s² (e.g., −0.15 to 0.1 m/s² as shown) and between time t₀ and t₄. Input shaft angle chart 1340 of FIG. 13C compares data 1342 against simulation data 1344, along an angle range −Φₘₐₓ to +Φₘₐₓ and between time t₀ and t₄. Yaw rate (ψDot) chart 1360 of FIG. 13D compares log data 1362 against simulation data 1364, along a range −\dot{ψ}ₘₐₓ to +\dot{ψ}ₘₐₓ (e.g., on the order of −0.5 to 0.5) and between time t₀ and t₄. And chart 1380 of FIG. 13E compares the reaction force between log data 1382 and simulation data 1384, along a range −Fₘₐₓ to +Fₘₐₓ and between time t₀ and t₄.

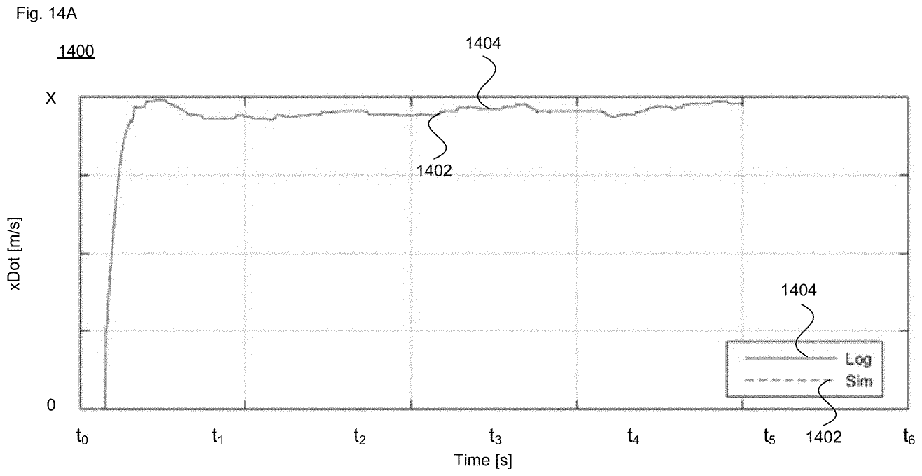

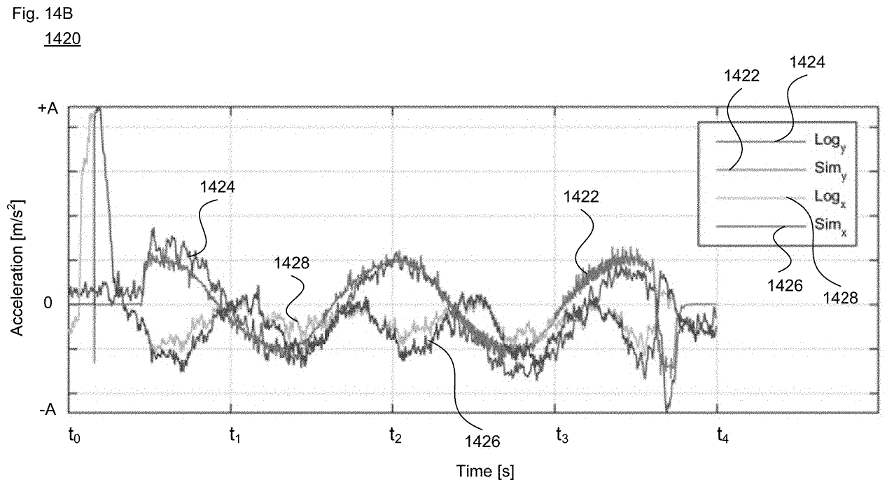

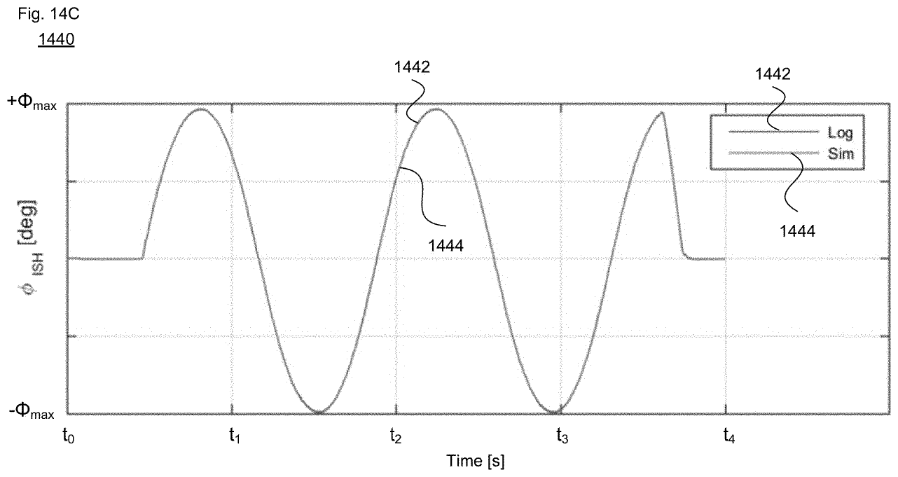

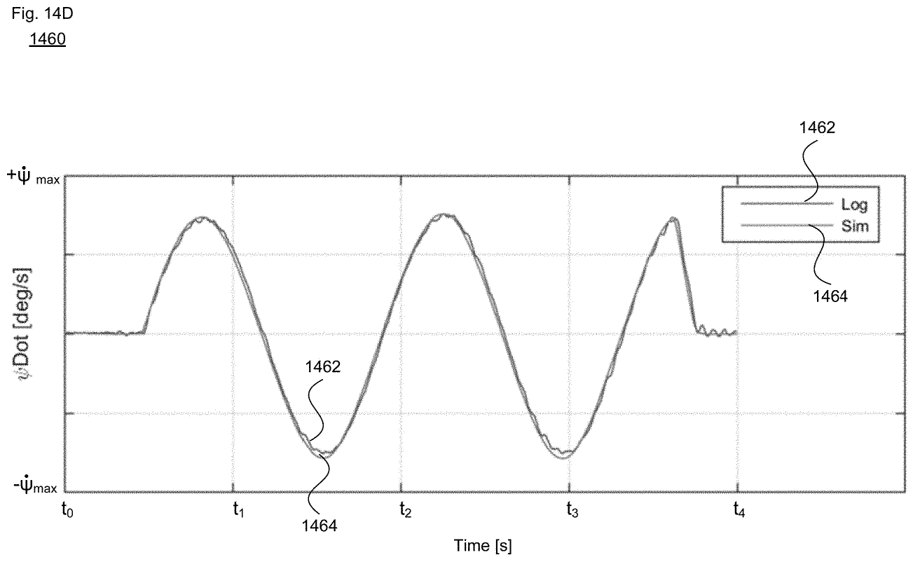

And FIGS. 14A-E are validation examples for a sine steer scenario with a speed of less than 1 m/s (about 2 mph). Speed chart 1400 of FIG. 14A compares simulation data 1402 against log data 1404 with a max speed of less than 1 m/s between time t₀ and t₆. Acceleration chart 1420 of FIG. 14B compares lateral simulation data 1422 against lateral log data 1424, and longitudinal simulation data 1426 against longitudinal log data 1428, both along an acceleration range substantially on the order of, e.g., −0.5 to 1 m/s²) and between time t₀ and t₄. Input shaft angle chart 1440 of FIG. 14C compares log data 1442 against simulation data 1444, along an angle range −Φₘₐₓ to +Φₘₐₓ and between time t₀ and t₄. Yaw rate (ψDot) chart 1460 of FIG. 14D compares log data 1462 against simulation data 1464, along a range to −\dot{ψ}ₘₐₓ to +\dot{ψ}ₘₐₓ between time t₀ and t₄. And chart 1480 of FIG. 14E compares the reaction force between log data 1482 and simulation data 1484, along a range −Fₘₐₓ to +Fₘₐₓ and between time t₀ and t₄.

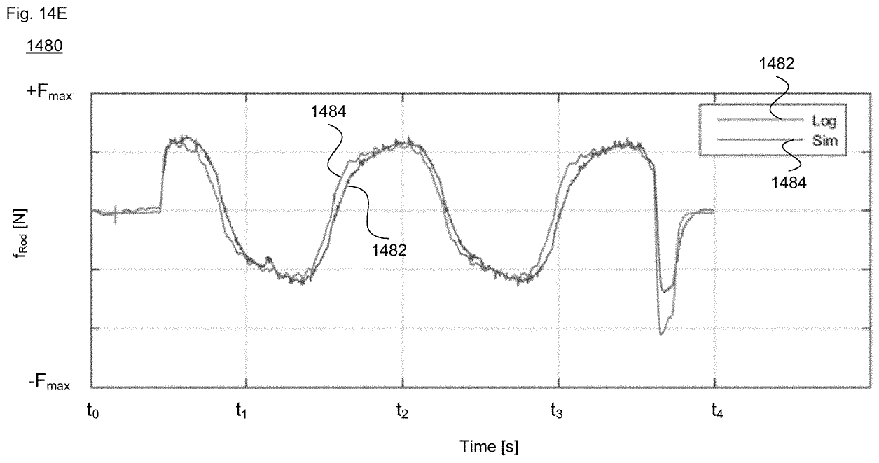

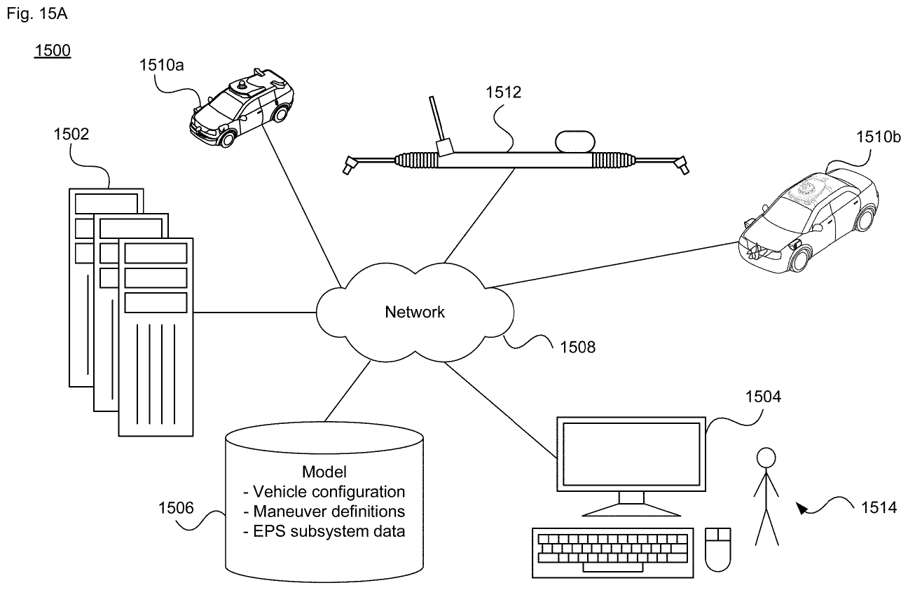

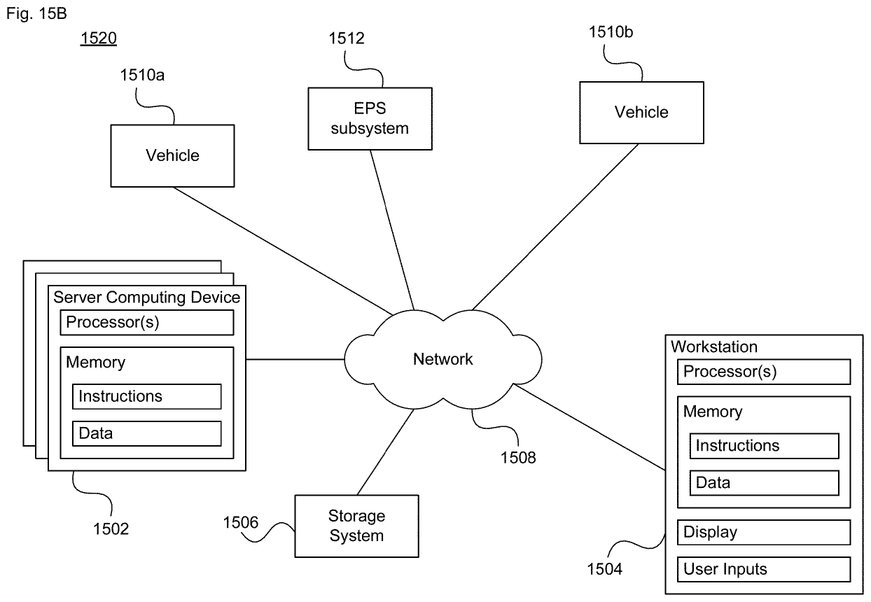

The model may be tested according to a virtual validation and verification approach when evaluating the EPS subsystem, e.g., in conjunction with HIL testing or SIL integration, for instance using a Monte-Carlo verification methodology. An exemplary system for model testing is shown in FIGS. 15A and 15B. In particular, FIGS. 15A and 15B are pictorial and functional diagrams, respectively, of an example system 1500 that includes a plurality of computing devices 1502, 1504 and a database or other storage system 1506 connected via a network 1508. The system 1500 incorporates parameters from one or more vehicle types 1510a, 1510b, vehicle subsystems such as EPS subsystem 1512, etc.

As shown in view 1520 of FIG. 15B, each of computing devices 1502 and 1504 may include one or more processors, memory, data and instructions. Such processors, memories, data and instructions may be configured similarly to the ones described above with regard to FIG. 3.

The various computing devices and database may communicate via one or more networks, such as network 1508. The network 1508, and intervening nodes, may include various configurations and protocols such as the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting and receiving data to and from other computing devices, such as modems and wireless interfaces.

In one example, computing device 1502 may include one or more server computing devices having a plurality of computing devices, e.g., a load balanced server farm, that exchange information with different nodes of a network for the purpose of receiving, processing and transmitting the data to and from other computing devices. For instance, computing device 1502 may include one or more server computing devices that are capable of communicating with computing device(s) 1504 via the network 1508. Server computing device 1502 may use network 1508 to transmit and present information to a user of one of the other computing devices. Computing device 1504 may be considered a workstation or other client computing device.

As shown in FIG. 15A computing device 1504 may be a personal computing device intended for use by a user 1514, and have all of the components normally used in connection with a personal computing device including a one or more processors (e.g., a central processing unit (CPU)), memory (e.g., RAM and internal hard drives) storing data and instructions, a display (e.g., a monitor having a screen, a touch-screen, a projector, a television, or other device, and user input devices (e.g., a mouse, keyboard, touchscreen or microphone). The client computing device/workstation may also include a camera for recording video streams, speakers, a network interface device, and all of the components used for connecting these elements to one another. In one example, the computing device 1504 may be configured to run a simulation environment (e.g., Simulink) using information from computer device 1502 and/or database 1506.

Storage system 1506 can be of any type of computerized storage capable of storing information accessible by the server computing devices 1502, such as a hard-drive, memory card, ROM, RAM, DVD, CD-ROM, flash drive and/or tape drive. In addition, storage system 910 may include a distributed storage system where data is stored on a plurality of different storage devices which may be physically located at the same or different geographic locations. Storage system 1506 may be connected to the computing devices via the network 1508 as shown in FIGS. 15A-B, and/or may be directly connected to or incorporated into any of the computing devices.

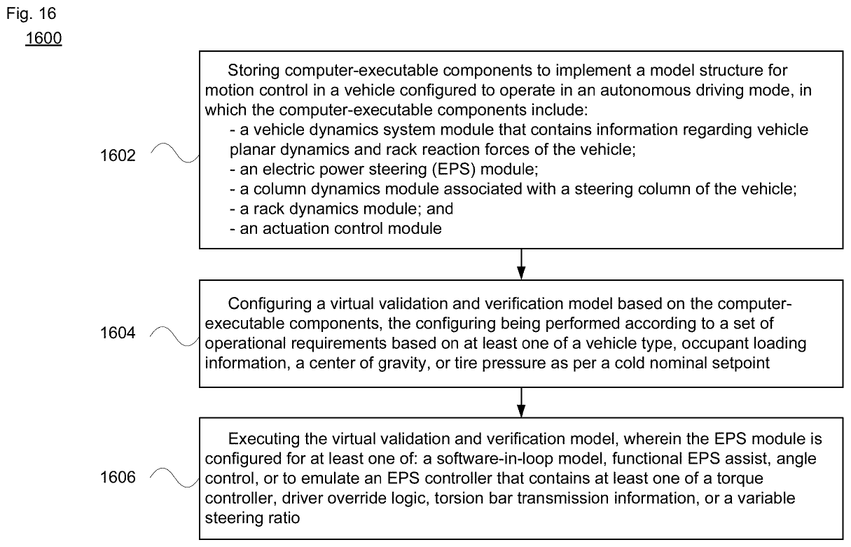

FIG. 16 illustrates an example of a computer-implemented method 1600. At block 1602, the method includes storing computer-executable components to implement a model structure for motion control in a vehicle configured to operate in an autonomous driving mode. The computer-executable components include: a vehicle dynamics system module that contains information regarding vehicle planar dynamics and rack reaction forces of the vehicle; an electric power steering (EPS) module; a column dynamics module associated with a steering column of the vehicle; a rack dynamics module; and an actuation control module. At block 1604, the method includes configuring a virtual validation and verification model based on the computer-executable components. The configuring is performed according to a set of operational requirements based on at least one of a vehicle type, occupant loading information, a center of gravity, or tire pressure as per a cold nominal setpoint. And at block 1606, the method includes executing the virtual validation and verification model, wherein the EPS module is configured for at least one of: a software-in-loop model, functional EPS assist, angle control, or to emulate an EPS controller that contains at least one of a torque controller, driver override logic, torsion bar transmission information, or a variable steering ratio.

Finally, the model verification technology discussed herein is applicable for various types of wheeled vehicles, including passenger cars, buses, RVs, trucks and the like.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements. The processes or other operations may be performed in a different order or simultaneously, unless expressly indicated otherwise herein.

1. A system, comprising:
memory that stores computer-executable components to implement a model structure for motion control in a vehicle configured to operate in an autonomous driving mode; and
one or more processors operatively coupled to the memory, the one or more processors being configured to execute the components in a virtual validation, and verification model, in which the components include:
a vehicle dynamics system module that contains information regarding vehicle planar dynamics and rack reaction forces of the vehicle;
an electric power steering (EPS) module;
a column dynamics module associated with a steering column of the vehicle;
a rack dynamics module; and
an actuation control module;
wherein the virtual validation and verification model is initially configured according to a set of operational requirements based on at least one of a vehicle type, occupant loading information, a center of gravity, or tire pressure as per a cold nominal setpoint.

2. The system of claim 1, wherein the virtual validation and verification model further includes a set of specific maneuver definitions selected from the group consisting of: sine steer, ramp steer, step steer, parking effort, a set of static steering kinematic properties, a suspension inertia identification, and suspension jacking effects.

3. The system of claim 1, wherein the vehicle dynamics system module includes data for a vehicle system, in which the vehicle system has a set of chassis/dynamics equations.

4. The system of claim 3, wherein the vehicle dynamics system module further includes kinematics and compliance information, in which the kinematics and compliance information are used to estimate final road wheel angles for each wheel of the vehicle.

5. The system of claim 4, wherein the vehicle dynamics system module further includes an axle model, in which the axle model estimates rack reaction forces subject to vehicle states and a wheels aligning moment around a z-axis.

6. The system of claim 5, wherein the vehicle dynamics system module further includes body vehicle movement, in which the body vehicle movement translates the vehicle states to global coordinates.

7. The system of claim 5, wherein the axle model is used to calculate the wheels aligning moment around the z-axis by calculating a front tires total aligning torque, a rear tires total aligning torque, and a jacking torque.

8. The system of claim 7, wherein the axel model is further used to calculate a rack reaction force based on the front tires total aligning torque multiplied by a steering arm length.

9. The system of claim 6 wherein the axle model is used by a kinematics and compliance module to calculate one or more tire angles.

10. The system of claim 9, wherein the one or more tire angles are used by a vehicle system module to determine vehicle state information in accordance with mu scaling and slip information.

11. The system of claim 10, wherein the vehicle state information includes at least one of a body-chassis translation, an angular positions, or an acceleration.

12. The system of claim 11, wherein the vehicle state information is used in a feedback loop to modify the axle model.

13. The system of claim 1, wherein the EPS module is configured for at least one of a software-in-loop model, functional EPS assist, or angle control.

14. The system of claim 1, wherein the EPS module is configured to emulate an EPS controller that contains at least one of a torque controller, driver override logic, torsion bar transmission information, or a variable steering ratio.

15. The system of claim 1, wherein the column dynamics module is associated with a set of steering parameters that include one or more of: a steering rack mass and friction parameter, mechanical properties of the steering column, torsion bar parameters, or an EPS transmission ratio for pinion and motor transmission.

16. The system of claim 1, wherein the rack dynamics module employs one or more parameters and functions to either simulate a rack endstop or to blend simulated and loped rack position/rate information.

17. The system of claim 1, wherein the actuation control module is used in simulations to control wheel longitudinal slip.

18. The system of claim 1, further comprising an experiment control module.

19. The system of claim 18, wherein the experiment control module is configured to implement a set of simulations in one or more driving modes including a manual mode, a partially autonomous configuration with driver takeover, or a fully autonomous configuration with no driver takeover.

20. The system of claim 1, further comprising an EPS log block configured to collect EPS-based signals.

21. A computer-implemented method, comprising:
storing computer-executable components to implement a model structure for motion control in a vehicle configured to operate in an autonomous driving mode, in which the computer-executable components include:
a vehicle dynamics system module that contains information regarding vehicle planar dynamics and rack reaction forces of the vehicle;
an electric power steering (EPS) module;
a column dynamics module associated with a steering column of the vehicle;
a rack dynamics module; and
an actuation control module;
configuring, by one or more processors, a virtual validation and verification model based on the computer-executable components, the configuring being performed according to a set of operational requirements based on at least one of a vehicle type, occupant loading information, a center of gravity, or tire pressure as per a cold nominal setpoint; and
executing, by one or more processors, the virtual validation and verification model, wherein the EPS module is configured for at least one of a software-in-loop model, functional EPS assist, angle control, or to emulate an EPS controller that contains at least one of a torque controller, driver override logic, torsion bar transmission information, or a variable steering ratio.
